(19) United States
(12) Patent Application Publication
(10) Pub. No.: US 2018/0097257 A1
(43) Pub. Date: Apr. 5, 2018

(54) ELECTROCHEMICAL SOLID CARBON-SULFUR LI-ION OR NA-ION BASED DEVICE AND USES THEREOF

(71) Applicant: Board of Regents, The University of Texas System, Austin, TX (US)

(72) Inventors: Maria Helena Sousa Soares De Oliveira Braga, Porto (PT); Jose Jorge Do Amaral Ferreira, MATOSINHOS (PT); Andrew Jackson Murchison, JR., San Jose, CA (US)

(21) Appl. No.: 15/700,414

(22) Filed: Sep. 11, 2017

Related U.S. Application Data
(63) Continuation-in-part of application No. PCT/IB2016/051451, filed on Mar. 12, 2015.
Application No. PCT/IB2016/051451 is a continuation-in-part of application No. PCT/IB2016/051776, filed on Mar. 27, 2015.

(30) Foreign Application Priority Data
Mar. 12, 2015 (PT) 108280
Mar. 27, 2015 (PT) 108327

(51) Int. Cl. H01M 10/0562; H01M 4/587; H01M 4/66; H01M 4/38; H01M 10/0525; H01M 10/054; H01G 11/68; H01G 11/32; H01G 11/56; H01G 11/06

(52) U.S. Cl. CPC H01M 10/0562; H01M 4/587; H01M 4/661; H01M 4/38; H01M 10/0525; H01M 2300/0071; H01G 11/68; H01G 11/32; H01G 11/56; H01G 11/06; H01M 10/054

(57) ABSTRACT

The disclosure includes layered electrochemical solid devices, in particular a supercapacitor and or a battery solid carbon-sulfur Li-ion or Na-ion glassy electrolyte-based device. The disclosure includes a layered electrochemical solid device including a positive electrode current collector including aluminum, a positive electrode including sulfur, a glass electrolyte, and carbon, the glass electrolyte, a negative electrode including a carbonaceous material, and a negative electrode current collector including copper. The glass electrolyte includes a compound of formula Li₃₋₂ₓMxHalO, Na₃₋₂ₓMₓHalO or Na₃₋₃ₓMₓHalO wherein: M is selected from the group consisting of boron, aluminium, magnesium, calcium, strontium, barium; Hal is selected from the group consisting of fluoride, chloride, bromide, iodide or mixtures thereof; X is the number of moles of M and 0<x≤0.01. The disclosure also includes a layered electrochemical solid device including the above described layers with inverted roles.

### PRIORITY CLAIM

The present application claims priority under 35 U.S.C. § 120 as a continuation-in-part of PCT Patent Application Serial No. PCT/IB2016/051451, filed Mar. 14, 2016, titled “AN ELECTROCHEMICAL SOLID CARBON-SULFUR LI-ION BASED DEVICE AND USES THEREOF,” which claims priority to Portuguese Patent Application Ser. No. 108280, filed Mar. 12, 2015.

The present application further claims priority under 35 U.S.C. § 120 as a continuation-in-part of PCT Patent Application Serial No. PCT/IB2016/051776, filed Mar. 29, 2016, titled “AN ELECTROCHEMICAL SOLID CARBON-SULFUR NA-ION BASED DEVICE AND USES THEREOF,” which claims priority to Portuguese Patent Application Ser. No. 108327, filed Mar. 27, 2015.

### TECHNICAL FIELD

The present disclosure relates to lithium (Li)-ion based or sodium (Na)-ion based batteries and supercapacitors with a carbon-sulfur electrode also containing a glass electrolyte.

### BACKGROUND

Since the advent of energy storage, humankind has been seeking a combined high power, high energy storage solution in a single device. Considerable efforts have been expended on the development of high-performance energy-storage devices such as Lithium-ion capacitors (LICs) and Lithium-ion batteries (LIBs) and, lately, Sodium-ion batteries (NIBs). High performance energy storage devices such as supercapacitors and batteries rely on different fundamental working principles—bulk versus surface—electron conduction and/or ion diffusion corresponding to electrochemical versus electrostatic energy storage (Vlad, A. et al. Hybrid supercapacitor-battery materials for fast electrochemical charge storage. 5c/. Rep. 4, 4315 (2014)). Electric double-layer capacitors (EDLCs), which store energy through accumulation of ions on the electrodes' interface, have low energy storage capacity but very high power density. However, in hybrid capacitors (Vlad, A. et al. Hybrid supercapacitor-battery materials for fast electrochemical charge storage. Sci. Rep. 4, 4315 (2014); Ghidiu, M., Lukatskaya, M. R., Zhao, M.-Q., Gogotsi, Y., Barsoum, M. Conductive two-dimensional titanium carbide ‘clay’ with high volumetric capacitance. Nature, 516, (2014); Li, H. B. et al. Amorphous nickel hydroxide nanospheres with ultrahigh capacitance and energy density as electrochemical pseudocapacitor materials. Nature Commun. 4, 1894 (2013); Liu, R., Duay, J., Lane, T., Lee, S. B. Synthesis and characterization of Ru02/poly(3,4-ethylenedioxythiophene) composite nanotubes for supercapacitors. Phys. Chem. Chem. Phys. 12, 4309 (2010); Jung, H. Y., Karimi, M. B., Hahm, M. G., Ajayan, P. M., Jung, Y. J., Transparent, flexible supercapacitors from nano-engineered carbon films. Sci. Rep. 2, 773 (2012)) like LICs, despite their recent advancement, the imbalance in kinetics between the two electrodes still remains a major drawback.

In the simplest configuration an EDLC consists of two electrodes immersed into a liquid electrolyte and separated by a membrane. Upon application of a voltage difference to the electrodes, the ions of the opposite charge of the electrolyte accumulate on the electrodes' interface in a quantity proportional to the applied voltage, forming a double layer capacitor (Ghidiu, M., Lukatskaya, M. R., Zhao, M.-Q., Gogotsi, Y., Barsoum, M. Conductive two-dimensional titanium carbide ‘clay’ with high volumetric capacitance. Nature, 516, (2014)). The charge storage mechanism in a typical EDLC is not Faradaic, which means that during the charge and discharge of this type of device, no charge transfer takes place across the electrolyte/electrode interface and the energy storage is of an electrostatic nature. In LICs, electrodes' carbonaceous materials may additionally exhibit chemical interactions with selected electrolytes, which involve fast and often reversible charge-transfer reactions between the carbon surface and the electrolyte ions; such processes are Faradaic. At a constant temperature and voltage, the ionic density on the carbon electrode surface is controlled by a balance between the changes in entropy and enthalpy of the system (Li, H. B. et al. Amorphous nickel hydroxide nanospheres with ultrahigh capacitance and energy density as electrochemical pseudocapacitor materials. Nature Commun. 4, 1894 (2013); Liu, Duay, J., Lane, T., Lee, S. B. Synthesis and characterization of Ru02/poly(3,4-ethylenedioxythiophene) composite nanotubes for supercapacitors. Phys. Chem. Chem. Phys. 12, 4309 (2010); Jung, H. Y., Karimi, M. B., Hahm, M. G., Ajayan, P. M., Jung, Y. J., Transparent, flexible supercapacitors from nano-engineered carbon films. Sci. Rep. 2, 773 (2012)). The sodium ion capacitors, NICs, were not studied in detail; it is expected that some of their properties can be inferred from LICs properties. The maximum voltage is generally determined by the electrochemical stability window of the selected electrolyte. Impurities and functional groups on carbon, however, may catalyze electrolyte decomposition, narrowing the operating voltage window.

Batteries on the other hand are composed by electrochemical cells. Each cell consists of positive and negative electrode separated by an electrolyte. Once the electrodes are connected externally, there are chemical reactions that occur at both electrodes, liberating electrons and enabling the current to be tapped by the user (Song, H. K., Lee, K. T., Kim, M. G., Nazar, L. F., Cho, J., Recent progress in nanostructured cathode materials for lithium secondary batteries. Adv. Fund. Mater. 20, 3818 (2010). Palomares, V., Serras, P., Villaluenga, I., Hueso, K. B., Carretero-Gonzalez, J., Rojo, T., Na-ion batteries, recent advances and present challenges to become low cost energy storage systems. Energy Environ. Sci. 5, 5884 (2012)).

Ford Motor pioneered the molten salt Na—S battery in Ford's “Ecostar” 1971, to power early-model electric cars (Heimann, B., Classic and Advanced Ceramics: From Fundamentals to Applications. John Wiley & Sons, Apr. 16, 2010; Koenig, A. A., Rasmussen, J. R. Development of a high specific power sodium sulfur cell. Proceedings of the 34th International Power Sources Symposium, p. 30. doi:10.1109/IPSS.1990.145783, 1990). Lately, developments with NASICON membrane allowed operation at 90° C. with all components remaining solid (Song, W., Cao, X., Wu, Z., Chen, J., Huangfu, K., Wang, X., Huang, Y., Ji, X. A study into the extracted ion number for NASICON structured Na₃V₂(PO₄)₃ in sodium-ion batteries Phys. Chem. Chem. Phys. 16, 17681 (2014)). Because of its high energy density, the Na—S battery has been proposed for space applications (Auxer, W. The PB sodium sulfur cell for satellite battery applications. Proceedings of the International Power Sources Symposium, 32nd, Cherry Hill, N.J. (Pennington, N.J.: Electrochemical Society). A88-16601 04-44: 49-54. (1986); NRL NaSBE Experiment 1997, <http.//www nrl.navy.mil/media/news-releases/1997/nrls-sodium-sulfur-battery-experiment-flies-aboard-sts87> retrieved, Mar. 21, 2015). Sodium-sulfur cells can be made space-qualified; in fact a test Na—S r cell was flown on the Space Shuttle. The Na—S flight experiment demonstrated a battery with a specific energy of 150 Wh/kg (3×Ni−MH battery energy density), operating at 350° C. It was launched on the STS-87 mission in November 1997, and demonstrated 10 days of experiment operation in orbit (NRL NaSBE Experiment 1997, <http://www.nrl.navy.mil/media/news-releases/1997/nrls-sodium-sulfur-battery-experiment-flies-aboard-sts87>> retrieved, Mar. 21, 2015). As highlighted above, molten salt Na—S batteries can be deployed to support the electric grid. In 2010, Presidio, Texas built the world's largest sodium-sulfur battery, which can provide 4 MW of power for up to eight hours when the city's lone line to the Texas power grid goes down (<http://www.popsci.com/technology/article/2010-04/texas-town-turns-monster-batter-backup-power>> Texas Town Installs a Monster Battery for Backup Power I Popular Science. (2010 July 2014); retrieved on Mar. 21, 2015). Under some market conditions, Na—S batteries provide value via energy arbitrage (charging battery when electricity is abundant/cheap, and discharging into the grid when electricity is more valuable) and voltage regulation (Walawalkar, R., Apt, J., Mancini, R. (2007). Economics of electric energy storage for energy arbitrage and regulation in New York. Energy Policy 35(4), 2558 (2007)). Na—S batteries are a possible energy storage technology to support renewable energy generation, specifically wind farms and solar generation plants. In the case of a wind farm, the battery would store energy during times of high wind but low power demand. This stored energy could then be discharged from the batteries during peak load periods. In addition to this power shifting, it is likely that Na—S batteries could be used throughout the day to assist in stabilizing the power output of the wind farm during wind fluctuations. These types of batteries present an option for energy storage in locations where other storage options are not feasible. For example, pumped-storage hydroelectricity facilities require significant space and water resources, while compressed air energy storage (CAES) requires some type of geologic feature such as a salt cave (Stahlkopf, Karl (June 2006). Taking Wind Mainstream. IEEE Spectrum, retrieved Mar. 21, 2015).

Sodium-ion batteries (NIBs) have been gaining increasing attention thanks to the natural abundance and low toxicity of sodium resources (Song, H. K., Lee, K. T., Kim, M. G., Nazar, L. F., Cho, J., Recent progress in nanostructured cathode materials for lithium secondary batteries. Adv. Fund. Mater. 20, 3818 (2010). Palomares, V., Serras, P., Villaluenga, I., Hueso, K. B., Carretero-Gonzalez, J., Rojo, T., Na-ion batteries, recent advances and present challenges to become low cost energy storage systems. Energy Environ. Sci. 5, 5884 (2012); Ellis, B. L., Nazar, L. F., Sodium and sodium-ion energy storage batteries. Curr. Opin. Solid State Mater. Sci. 16, 168 (2012); Heimann, B., Classic and Advanced Ceramics: From Fundamentals to Applications. John Wiley & Sons, Apr. 16, 2010; Song, W., Cao, X., Wu, Z., Chen, J., Huangfu, K., Wang, X., Huang, Y., Ji, X. A study into the extracted ion number for NASICON structured Na₃V₂(PO₄)₃ in sodium-ion batteries Phys. Chem. Chem. Phys. 16, 17681 (2014).). Furthermore, sodium is located just below lithium in the s block. Therefore, similar chemical approaches including a synthetic strategy, intercalation/alloying/conversion chemistry, and characterization methods utilized in electrode materials for LIBs could be applied to develop electrode materials for NIBs. Despite potential disadvantages, including larger size (0.98-1.02 A) of Na cations (approximately, 20-25% larger than Li cations, 0.76-0.78 A) and higher redox potential (−2.71 V vs. SHE) of Na/Na+ compared to Li analogues (−3.04 V vs. SHE) of Li/Li+(17), the different interactions between the guest Na-cations and the host crystal structures can influence the kinetics as well as thermodynamic properties of NIBs, and this may provide an avenue for a breakthrough technology to surpass LIBs (Ong, S. P., Chevrier, V. L, Hautier, G., Jain, A., Moore, C, Kim, S., Ma, X. H., Ceder, G., Voltage, Stability and Diffusion Barrier Differences Between Sodium-ion and Lithium-ion Intercalation Materials. Energy Environ. Sci., 4, 3680 (2011)). As an effort to find alternatives to graphite in NIBs, Doeff et al. demonstrated the reversible de/insertion of Na ions into disordered carbons for an anode in NIBs (Doeff, M. M., Ma, Y. P., Visco, S. J., Dejonghe, L. C, Electrochemical Insertion of Sodium into Carbon. J. Electrochem. Soc, 140, L169 (1993)). Most of the sodium ions are electrochemically inserted into nanoporous voids of hard carbon (HC), which is built by disordered graphene stacking—the so-called ‘house of cards’ type model. Two independent research groups lead by Dahn (Stevens, D. A., Dahn J. R. High capacity anode materials for rechargeable sodium-ion batteries. J. Electrochem. Soc. 147, 1271 (2000)) and Tirado (Alcantara, R., Lavela, P., Ortiz, G. F., Tirado, J. L, Carbon Microspheres Obtained from Resorcinol-Formaldehyde as High-Capacity Electrodes for Sodium-Ion Batteries. Electrochem. Solid-Stote Lett, 8, A222 (2005)) demonstrated that the initial specific capacity of hard carbon in NIBs is ca. 300 mAh/g close to that of graphite in LIBs. Most of the reversible capacity is related to sodium storage inside nanocavities. However, this hard carbon electrode exhibited significant loss of capacity within 10 cycles with poor rate performance.

These facts are disclosed in order to illustrate the technical problem addressed by the present disclosure.

### BRIEF DESCRIPTION OF THE DRAWINGS

The following figures provide preferred embodiments for illustrating the description and should not be seen as limiting the scope of present disclosure.

FIGS. 1A and 1B show X-ray diffraction (XRD) patterns of the electrodes prior to device assembly. FIG. 1A shows the carbon black negative electrode showing amorphous carbon and graphite. FIG. 1B shows the sulfur based positive electrode showing an amorphous phase (the electrolyte and carbon), and textured crystalline sulfur. The experiment was performed in order to mitigate the amorphous component diffuse scattering.

FIGS. 2A-2G show the galvanostatic charge/discharge characterization cycles for devices 0 and 1. FIG. 2A shows device 0 during experiments b and c. FIG. 2B is a simplified schematic representation of the processes occurring during galvanostatic charge/discharge of the present devices. The E represents the electric field and the arrow above it its direction. FIG. 2C is a zoom of the first seconds of the discharge of device 0 during experiment c. FIG. 2D shows the charge/discharge of device 0, during experiment a. FIG. 2E shows the charge/discharge of device 1 during experiment a. Burst discharge took place at Voc. FIG. 2F shows the charge/discharge of device 1 during experiment c. FIG. 2G shows the charge/discharge of device 1 during experiment d.

FIGS. 3A-3I show the charge/discharge characterization cycles of devices 0, 1, 2 and 4. FIG. 3A shows the charges of devices 0 and 1. Evolution of electrolyte's charge transfer resistance, j, during consecutive experiments. FIG. 3B shows the first charge of device 2. FIG. 3C is a zoom of the discharge of device 2@ b showing EDLC burst and battery mode at Voc discharge. FIG. 3D shows the charge of device 4 during experiment c. Capacitance evolution during charge. FIG. 3E shows the discharge of device 4 during experiment c. FIG. 3F shows the maximum capacity determination for device 4 during charge at constant voltage (5 V) in experiment d. FIG. 3G is a schematic representation of the equivalent circuit after open circuit's discharge correspondent to FIG. 2B(4). Ra=2Re+Ri (see Examples). FIG. 3H shows the Electrochemical Impedance Spectroscopy (EIS) of device 0 showing EDLCs capacitances and internal resistances evolution after 13 days and 60 cycles: Voc@ 13 days=0.30 V vs. Li/Li⁺ and Rn=35.6Ω, Rc=1,179Ω, Cc=0.10 nF, Rs=748Ω, Cs=0.90 m F. After 48 days and 80 cycles: Voc@48 days=0.32 V vs. Li/Li+ and Rn=70.4Ω, Rc=136Ω, Cc=0.14 nF, Rs−1704Ω, Cs=0.61 mF. FIG. 3I shows the charge/discharge cycles of device 1 during experiment e.

FIGS. 4A-4E show the electrochemical and physical characterizations of devices 0, 1, 2, 3 and 4. FIG. 4A shows the cyclic voltammetry (CV) of device 0 during charge and discharge at 1 mV/s. FIG. 4B is a Ragone plot (27) with data from (28-30). The comparison of the energy and power density of MPG-MSCs with TG-MSCs, MPG-SSCs (28), commercially applied electrolytic capacitors (23), lithium thin-film batteries (30), Panasonic Li-ion battery (30), and devices 0, 1, 2, 3, and 4 taking into consideration two modes of the same device: EDLC and battery and just EDLC for device 4@c. FIG. 4C shows capacitance in Farad (F) as a function of the capacity in (mAh) during charge of device 1 in experiment a. FIG. 4D shows capacitance and cell voltage as a function of time for device 0 in experiment b. FIG. 4E shows capacitance's dependency on the voltage rate (Δν/Δï) for device 0.

FIGS. 5A-5D show the electrochemical impedance spectroscopy (EIS) of device 0 after 3, 13 and 48 days of fabrication and device 1 after 5 days of fabrication. FIG. 5A shows the EIS of device 0@3 days and before cycling, showing: Rn=47.7Ω, Rc=122Ω, Cc=0.82×10⁹ F, R=32.1×10⁶Ω, C 11.5×10⁹ F (Voc@ 3 days=0.42 V vs. Li/Li^{z}). FIG. 5B is a zoom of a in comparison with the EIS obtained after 48 days, showing the semi-circle characteristic of the EDLC at the carbon negative electrode interface in parallel with its internal resistance. The capacitance of the carbon-electrolyte EDLC and its associated internal resistance do not improve considerably with shelf time and cycling. FIG. 5C shows the EIS of device 0(5) 13 days and 60 cycles and C charging rates (0.01 C to 0.04 C of the device and 0.04 C to 0.15 C of the battery mode) showing: Ra=35.6Ω, Rc=1179Ω, Cc=0.10×10′⁹ F, Rs.interface=748Ω, Cs.interface=0.90×10³ F and @48 days and 80 cycles at different C charging rates (0.01 C to 0.04 C of the device and 0.04 C to 0.15 C of the battery mode) showing: Ra=70.4Ω, Rc=136Ω, Cc=0.14×10-9 F, Rs.interface−1704Ω, Cs.interface−0.61×10⁻³ F (Voc@13 days=0.30 V vs. Li/Li+ and Voc@48 days=0.32 V vs. Li/Li). The capacitance and resistance of the EDLCs at the sulfur electrode do not improve much from the 13th to 48th day and with cycling, but they improve considerably from the 3rd day, eventually due to cycling conditioning. FIG. 5D shows the EIS of device 1 after 5 shelf days and after 52 galvanostatic cycles at C-charge and discharge rate (0.02 C of the device and 0.08 C of the battery mode), showing three semi-circles corresponding to three capacitors in serial, possibly the configuration in FIG. 2B(5): Ra=25.4Ω, Rc=8.7Ω, Cc=43.2×10⁹ F, Rs.interface=1408Ω, Cs.interface=0.27×10⁻³ F, Rs.inner space−1418Ω, Cs.inner space=0.78×10³ F (Voc@5 days=−0.07 V vs. LivLi).

FIGS. 6A-6C show the galvanostatic charges/discharges of device 0, 1 and 3. FIG. 6A shows the charges/discharges 0@e and 0@f were performed in the same day. The device 0@f discharges the EDLCs in Is (AV=5.13 V). FIG. 6B shows the device 1@f discharges the EDLCs in Is or less (AV=5.15 V). FIG. 6C shows the device 3@g discharges the EDLCs in Is or less (AV=6.75 V).

FIGS. 7A-7E show cyclic voltammetry (CV) for device 0. FIG. 7A shows the charge and discharge at 500 mV/s. FIG. 7B shows the charge and discharge at 500 mV/s. FIG. 7C shows the charge and discharge at 100 mV/s. FIG. 7D shows the charge at 50 mV/s. FIG. 7E shows the charge and discharge at 10 mV/s.

FIGS. 8A-8B show cyclic voltammetry for device 4. FIG. 8A shows charge and discharge at 200 mV/s. FIG. 8B shows charge at 50 mV/s.

FIGS. 9A-9B show galvanostatic charges of devices 0@c and 3@a. FIG. 9A shows device 0's capacitance due to its battery mode charging is 12.9 F. The maximum capacitance in this measurement is 32 F, 16 F/g cell and 535 F/g carbon(−). FIG. 9B shows device 3's capacitance due to its battery mode is approx. 47 F. The maximum capacitance in this measurement is 132 F, 90 F/g cell and 2,880 F/g carbon(−).

FIG. 10 to FIG. 20 relate to Li-based materials and devices.

FIG. 10 shows X-ray diffraction (XRD) patterns of the carbon black negative electrode showing amorphous carbon and graphite.

FIG. 11 shows the galvanostatic charge/discharge characterization cycles for device 1 during experiment a, which was performed after 10 galvanostatic charge/discharge cycles.

FIG. 12 shows the galvanostatic charge curve for device 1 during experiment a (the same of FIG. 10). This curve is the third charging curve shown in FIG. 10. The goal is to highlight capacity and energy density.

FIG. 13 shows the galvanostatic charge curve for device 1 during experiment a (the same of FIG. 10). This curve is the third charging curve shown in FIG. 10. The goal is to highlight the device's capacitance.

FIG. 14 shows the galvanostatic charge/discharge characterization cycles for device 1 during experiment c, which was performed after 15 galvanostatic charge/discharge cycles (including experiment a). In these experiments, for the same charging current of 25 mA, the voltage reaches 10 V. It can be observed a small hump after burst discharge that it is attributed to the battery mode discharge.

FIG. 15 shows the Galvanostatic charge curve for device 1 during experiment c (the same of FIG. 13). This curve is the first charging curve shown in FIG. 13. The goal is to highlight the initial voltage, the initial voltage drop to 6 V and the small hump after burst discharge that it is attributed to the battery mode discharge even if it cannot clearly identify the battery mode charge.

FIG. 16 shows the galvanostatic charge/discharge characterization cycles for device 2 during experiment a, which was performed after 20 galvanostatic charge/discharge cycles. In these experiments, performed at a charging current of 15 mA, the voltage reaches approximately 10 V. It cannot be observed any hump after burst discharge eventually meaning that a new EDLC was formed, not letting the battery mode discharge.

FIG. 17 shows a simplified schematic representation of the processes occurring during galvanostatic charge/discharge of the present devices.

FIG. 18 shows the galvanostatic charge/discharge characterization cycles for device 2 during experiment b, which was performed after 24 cycles (including those in FIG. 15). In these experiments, performed at a charging current of 15 mA, the voltage reaches approximately 10 V. A hump cannot be observed after burst discharge meaning that a new EDLC was formed, not letting the battery mode discharge.

FIG. 19 shows the discharge burst characterization (I=˜0 mA) for device 2 during experiment b, which was performed after 24 galvanostatic charge/discharge cycles (including those in FIG. 15). It cannot be observed a AV corresponding to the capacitor's mode internal resistance. FIG. 19 Part A shows the discharge of the first cycle in FIG. 17. FIG. 19, Part B shows the discharge of the second cycle in FIG. 17. FIG. 19, Part C shows the discharge of the third cycle in FIG. 17.

FIG. 20 shows the initial galvanostatic charge/discharge cycles performed on device 1 (this experiment was performed before a). Evidence of polarization inversion and of charge while “discharging”.

FIG. 21 is a schematic representation of the equivalent circuit after open circuit's discharge correspondent to FIG. 16(3). Rn=2Rₑ+Ri.

### DETAILED DESCRIPTION

The present disclosure relates to the development and improvement of lithium-ion electrolyte composition, layered electrochemical solid devices, in particular to the development of a new device; a supercapacitor and battery solid carbon-sulfur Li-ion based device with autonomous dual functionality which is charged from the Li-rich glassy electrolyte solid electrolyte glass comprising a safe, environmentally friendly and inexpensive device.

Unlike the majority of lithium ion batteries available today, the present devices do not present an under-voltage, over-voltage or thermal runaway risk. They present a dual mode of operation, both a high energy battery mode and power capacity supercapacitor mode a long with a burst discharge of one (1) second or less. In the supercapacitor mode of a device, it can store more energy than any other known capacitor and in the battery mode several of the present devices store more energy for a longer period than most Li-ion batteries.

### Li-ion Compositions and Devices

In this document it is presented several energy storage type of devices which are neither hybrid capacitors nor lithium batteries (Goodenough, J. B., Park, K.-S., J. Am. Chem. Soc, 135 (4), 1167 (2013); Choi, N.-S. et al. Challenges facing lithium batteries and electrical double-layer capacitors. Angew. Chem. Int. Ed. 51, 9994 (2012); Conway, B. E., Transition from “supercapacitor” to “battery” behavior in electrochemical energy storage. J. Electrochem. Soc. 138, 1539 (1991)). These devices in their battery modes, are charged (lithiated) from the high lithium content in the solid electrolyte, the only material initially containing lithium ions. Each storage device is sequentially charged as an EDLC and battery—keeping features of a Li—S battery cell (Tarascon, J.-M., Armand, M., Issues and challenges facing rechargeable lithium batteries. Nature 414, 359 (2001); Ma, G., A lithium anode protection guided highly-stable lithium-sulfur battery. Chem. Commun. 50, 14209 (2014); Manthiram, A., Fu, Y., Chung, S.-H., Zu, C, Su, Y.-S. Rechargeable Lithium-Sulfur Batteries, Chem. Rev. 114, 11751 (2014); Zheng, S. et al. J. High Performance C/S Composite Cathodes with Conventional Carbonate-Based Electrolytes in Li—S Battery. Sci. Rep. 4, 4842 (2014); Ji, L. et al. Graphene Oxide as a Sulfur Immobilizer in High Performance Lithium/Sulfur Cells, JACS, 133, 18522 (2011); Yao, H. et al. Improved lithium-sulfur batteries with a conductive coating on the separator to prevent the accumulation of inactive S-related species at the cathode-separator interface. Energy Environ. Sci. 7, 3381 (2014); Zhang, S. S. Liquid electrolyte lithium/sulfur battery: Fundamental chemistry, problems, and solutions. Power Sources, 231, 153 (2013); Xie, J. et al. Preparation of three-dimensional hybrid nanostructure-encapsulated sulfur cathode for high-rate lithium sulfur batteries. J. Power Sources, 253, 55 (2014); Jayaprakash, N., Shen, J., Moganty, S. S., Corona, A., Archer, L. A. Porous Hollow Carbon@Sulfur Composites for High-Power Lithium-Sulfur Batteries. Angew. Chem. Int. Ed. 50, 5904 (2011); Nagao, M., Hayashi, A., Tatsumisago, M. Fabrication of favorable interface between sulfide solid electrolyte and Li metal electrode for bulk-type solid-state Li/S battery, Electrochem. Commun. 22, 177 (2012); Lu, S., Chen, Y., Wu, X., Wang, Z., Yang Li, Y. Three-Dimensional Sulfur/Graphene Multifunctional Hybrid Sponges for Lithium-Sulfur Batteries with Large Areal Mass Loading. Sci. Rep. 4, 4629 (2014)—and then finally as an EDLC. This order is reverted during discharge. It is an autonomous switching dual functioning device, which can present a device voltage of 9 V. This device will impact a very broad spectrum of applications especially in the transportation, grid stationary, and aerospace.

In an embodiment, the present disclosure relates to a supercapacitor and battery solid carbon-sulfur Li-ion based device with autonomous dual functionality and charged from the Li-rich glassy electrolyte.

An aspect of the present subject-matter is related to a layered electrochemical solid device comprising a positive electrode current collector, a positive electrode, a glass electrolyte, a negative electrode and a negative electrode current collector wherein the positive electrode current collector comprises aluminum; the positive electrode comprises sulfur, a glass electrolyte of formula Li₃₋₂ₓMₓHalO and carbon; the glass electrolyte composition comprising a compound of formula Li₃₋₂ₓMₓHalO wherein: M is selected from the group consisting of boron, aluminum, magnesium, calcium, strontium, barium; Hal is selected from the group consisting of fluoride, chloride, bromide, iodide or mixtures thereof; X is the number of moles of M and 0<x<0.01; the negative electrode comprises a carbonaceous material; and the negative electrode current collector comprises copper.

In some cases, the collectors can have a predominant role. They can function as electrodes being the copper+carbon black the positive electrode and the sulfur+glass electrolyte+carbon in aluminum the negative electrode. This configuration makes the device works reversely to what was described for charge and discharge.

In some cases, when the role of the collectors is preponderant, they may overcome the role of the electrodes, reversing the functions of the electrodes and leading to a device with inverted electrodes.

The present subject-matter relates to a layered electrochemical solid device comprising the above described layers with inverted roles.

In an embodiment, the positive electrode may comprise 3-80% (w/w) of sulfur, and 3-80% (w/w) of the electrolyte composition described herein and less than 20% (w/w) of a carbon, in particular less than 10% (w/w).

In an embodiment, the positive electrode may comprise 30-50% (w/w) of sulfur, and 30-50% (w/w) of the electrolyte composition described herein and less than 20% (w/w) of a carbon, in particular 10% of carbon.

In an embodiment, the positive electrode composition may be grinded in ethanol and a slurry is prepared. This slurry can be deposited, printed or painted in the positive electrode current collector comprising aluminum.

In an embodiment for better results, X may be 0.002, 0.005, 0.007 or 0.01.

In an embodiment for better results, Hal may be a mixture of chloride and iodide, or chloride and bromide, or fluoride and iodide.

In an embodiment for better results, Hal is Hal=0.5 Cl+0.5 I.

In an embodiment for better results, the electrodes may be suitable to be charged with Li-ions from the electrolyte.

In an embodiment for better results, the carbonaceous material of the negative electrode is selected from the group consisting of carbon black, graphite, graphene, carbon nanotubes, spongy carbon, carbon foam, carbon white, carbon composite, carbon paper, carbon fibers, carbon film, printed carbon, and mixtures thereof.

In an embodiment for better results, the aluminum of the positive electrode current collector is selected from: an aluminum foam, aluminum film, aluminum foil, aluminum composite, aluminum wires, aluminum surface.

In an embodiment for better results, the copper of the negative electrode current collector is selected from: a copper foam, copper thin film, copper foil, copper composite, copper wires, copper surface, and or other engineered form of copper.

In an embodiment for better results, the positive electrode further comprises an alcohol, an organic solvent, a polymer, or mixtures thereof. Preferably, the alcohol is ethanol, methanol, or mixtures thereof; preferably absolute methanol, absolute ethanol, or mixtures thereof.

In an embodiment for better results, the device may further comprises a confinement, protection or wrapping immersement. Preferably, the confinement, protection or wrapping immersement is by a polymer or a resin. More preferably, the resin is an epoxy or the polymer is a water-proof polymer, or a water-resistant polymer, or a flexible polymer, or a rigid polymer, or a non-flammable polymer.

Another aspect of the present invention discloses a capacitor comprising the layered electrochemical solid device described in the present disclosure.

The disclosure further includes battery comprising the layered electrochemical solid device described in the present disclosure.

The disclosure further includes a dual mode battery comprising the layered electrochemical solid device described in the present disclosure.

The disclosure further includes an electrical actuator comprising the layered electrochemical solid device described in the present disclosure.

The disclosure further includes a sonar comprising the layered electrochemical solid device described in the present disclosure.

The disclosure further includes a transducer comprising the layered electrochemical solid device described in the present disclosure.

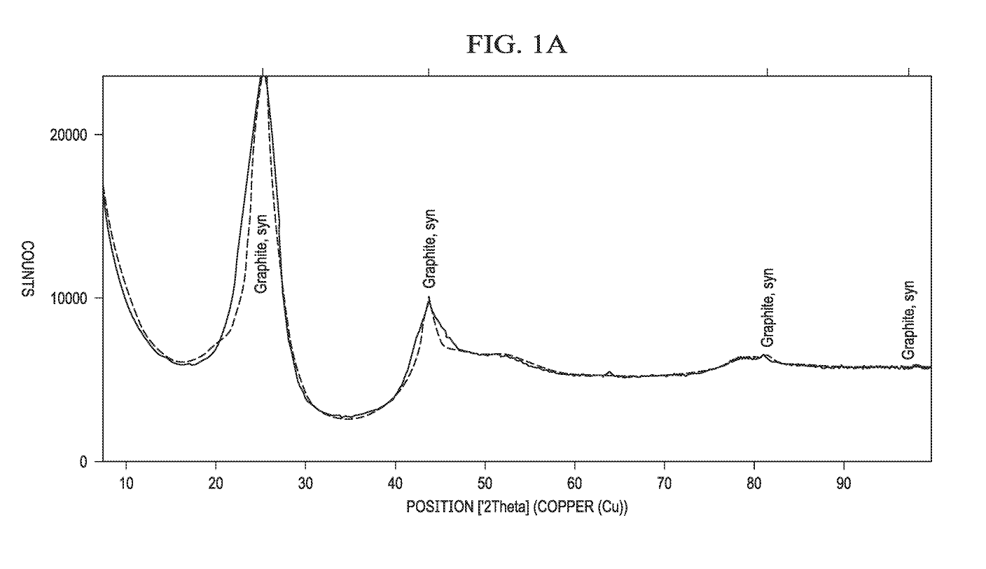

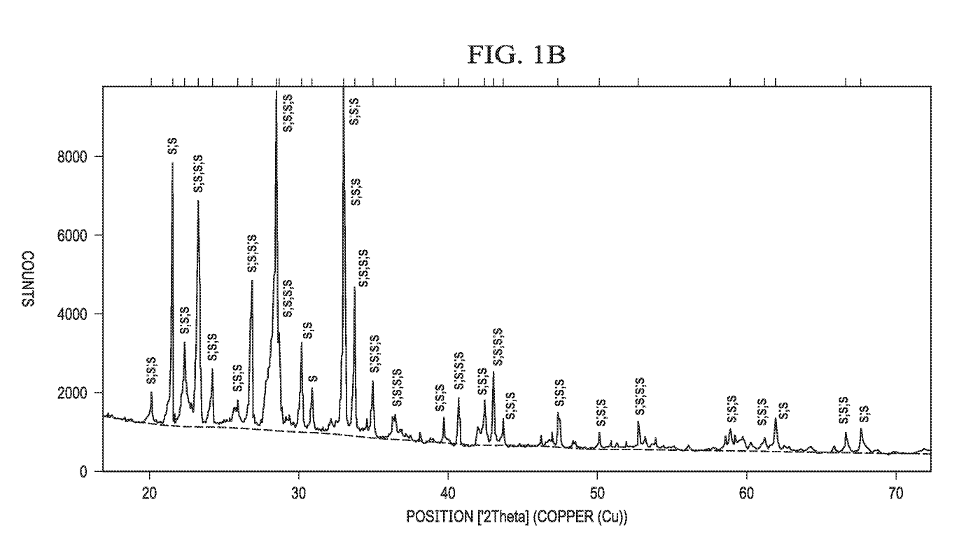

In an embodiment, the present disclosure relates to a solid state bulk energy storage device working autonomously, simultaneously or independently as a supercapacitor and as a battery. On charge, the supercapacitor is the last mode to be fully charged and on discharge, the supercapacitor mode is the first to be discharged. The device is composed of a copper bulk collector, a negative electrode of carbon black (C) which is mostly graphite (FIG. 1A), a doped glassy electrolyte (Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014)), Li₃ClO based, a positive electrode comprised of a mixture of: sulfur (Ss), a glassy electrolyte, and carbon black, deposited on an aluminum bulk collector. If some sulfur reacts with the electrolyte, during electrode preparation, it is most likely just at the surface forming an amorphous phase that cannot be distinguished from the other amorphous phases already present (glassy electrolyte and carbon black), FIG. 1B. The surface dimensions of the cells' electrodes are 2.5×2.5 cm² or 2.5×3.5 cm² with a loading of 0.20-0.40 g/cm² of electrode materials and electrolyte. The sulfur loading can be 0.018-0.040 g/cm². Collectors have an extended functionality; besides being an electronic transport media, they have a support and heat dissipation functionality which is not intrinsic to the device, among other functionality. The cells have 0.15-0.35 g/cm² of electrolyte as separator. The cell's thickness is 0.20-0.35 cm. The electrodes, electrolyte and collectors were accountable to the device's weight.

In an embodiment, the wide electrochemical window of the electrolyte (Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014)) makes it compatible for use with a broad spectrum of battery and supercapacitor electrodes. The Li-rich transport characteristics of the electrolyte permit enhanced cell component kinetics and increased life cycle. Moreover, the battery mode is lithiated from the electrolyte and in the sulfur based electrode the Li-ions do not cross the electrode's surface allowing for a new set of electrode combinations such as the carbon-sulfur pair presented herein. The open circuit's voltage at the time of cell fabrication, is lower than 0.6 V permitting for extremely safe transportation and storage. Consequently, the device can be charged at the destination as battery or/and supercapacitor.

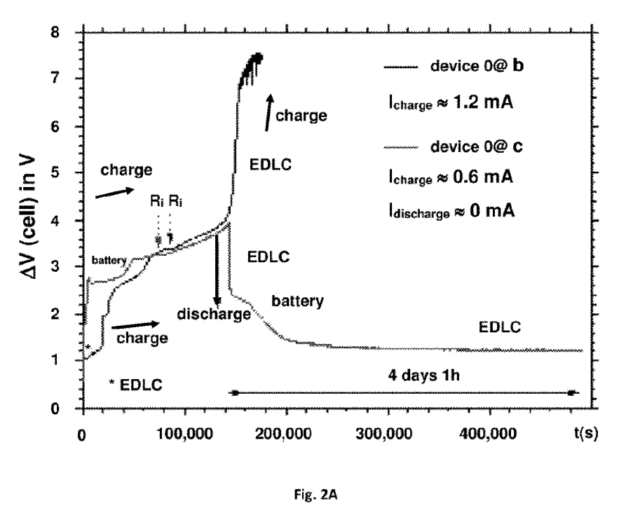

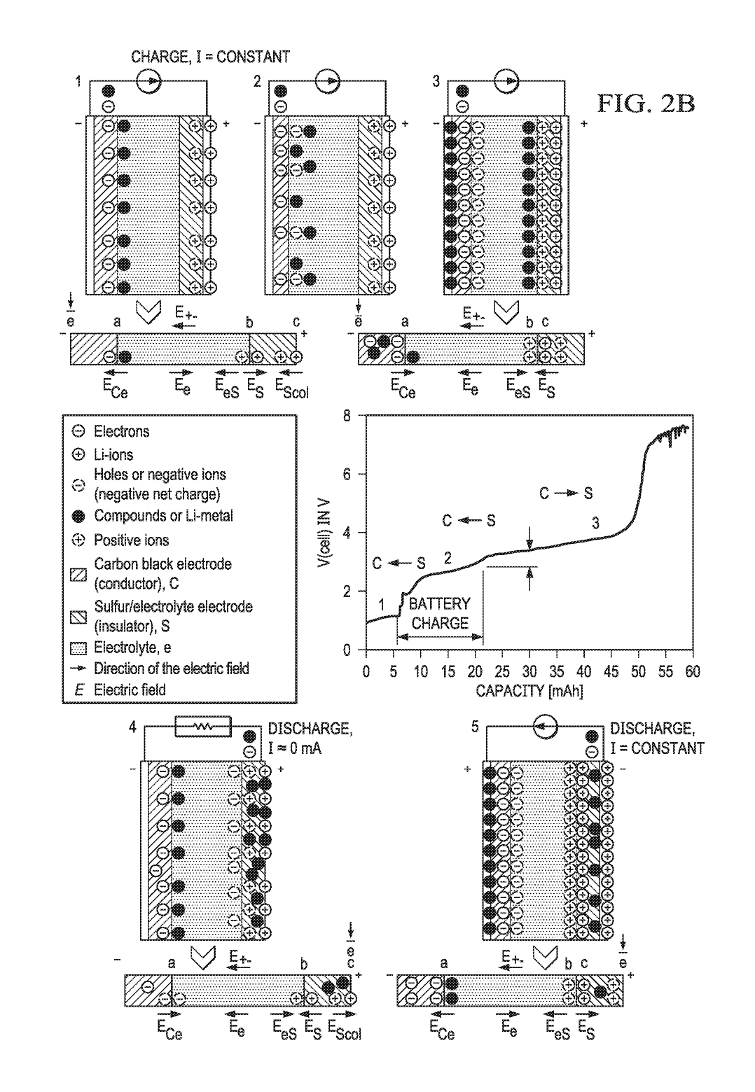

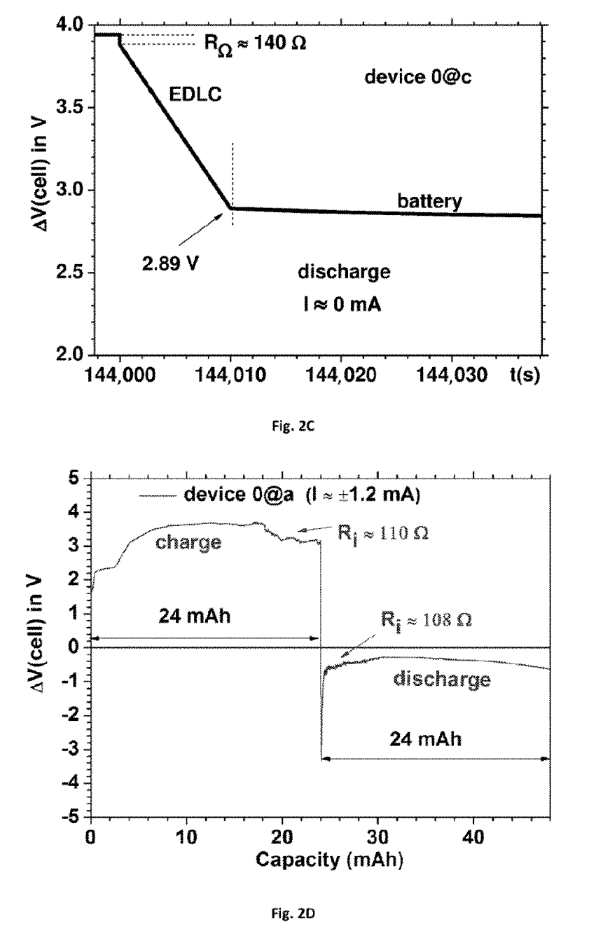

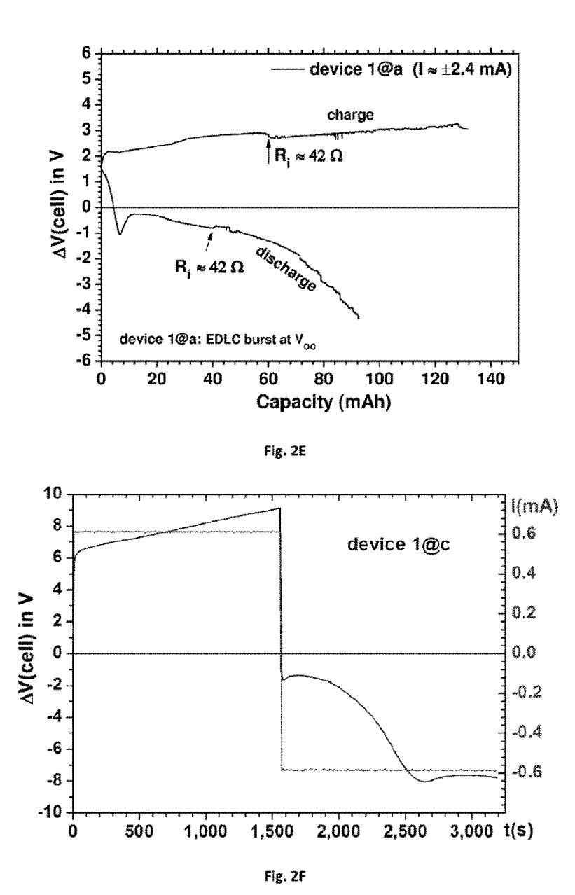

In an embodiment, two galvanostatic charging processes for the carbon(C)/electrolyte/sulfur based(S)—device 0 are shown in FIG. 2A, at a current of 0.6 mA and 1.2 mA. The EDLCs within device 0@b begin to charge at Δν=1 V achieving a maximum capacity of 5.8 mAh. The capacitor only starts charging at 1 V due to the resistance difference between the positive and negative electrodes including the electrolyte's internal resistance which will be overcome when the EDLCs start to charge as presented in FIG. 2B(1) after having discharged in a configuration like the one in FIG. 2B(4), as will be detailed herein. FIG. 2B shows the current explanation for the physical and chemical processes in the device during galvanostatic charge and discharge. In FIG. 2B(1), at the carbon electrode and after the electrons conduction and accumulation at the surface, an EDLC(a) will be formed with the separator electrolyte's Li-ions that accumulate at the interface. This process leaves Li-ions holes (vacancies) on the opposite surface of the separator electrolyte (at the positive electrode interface), which correspond to a negative net charge. At the sulfur based electrode, 46 wt of the electrode is comprised by the lithium-rich electrolyte whose Li-ions accumulate at the surface. With the Li-ion vacancies within the separator electrolyte, the latter constitute the EDLC(b) at the positive electrode's interface.

At the interface electrode/collector another EDLC(c) forms from the Li-ion vacancies on the sulfur based electrode and the positive ions Al³⁺ at the surface of the Al collector. In FIG. 2B(2), the Li-ions of the electrolyte at the carbon electrode initiate diffusion into the electrode. In the graph of FIG. 2B this phenomenon can be observed above 1.26 V, the voltage at which the Li-ion battery mode begins to charge. This mode of charge is also visible for device 0@c, above 1.6 V presented in FIG. 2A. The shape of the charge curve for this mode is actually very similar to a Li—S battery correspondent charge curve (Yao, H. et al. Improved lithium-sulfur batteries with a conductive coating on the separator to prevent the accumulation of inactive S-related species at the cathode-separator interface. Energy Environ. Sci. 7, 3381 (2014); Jayaprakash, N., Shen, J., Moganty, S. S., Corona, A., Archer, L. A. Porous Hollow Carbon@Sulfur Composites for High-Power Lithium-Sulfur Batteries. Angew. Chem. Int. Ed. 50, 5904 (2011)). The inbound ions within the carbon electrode will be reduced by the electrons and LiC₆ will be formed. Device 0@ b is fully charged at 22.0 mAh (FIG. 2A and FIG. 2B) in its battery mode. The capacity of this mode is 16.2 mAh corresponding to a capacity of 324 mAh/g carbon(−) (87% of the theoretical capacity of the graphite). The carbon electrode, which is composed of amorphous carbon and graphite, determines the battery's maximum capacity. During battery mode charge, the EDLCs(b,c) that were formed at the positive electrode are accountable for the voltage difference of 0.6-1.1 V over the battery potential. A C—S battery is theoretically charged at 2.1-2.5 V (a Li—S battery is fully charged at 2.4-2.8 V (Jayaprakash, N., Shen, J., Moganty, S. S., Corona, A., Archer, L. A. Porous Hollow Carbon@Sulfur Composites for High-Power Lithium-Sulfur Batteries. Angew. Chem. Int. Ed. 50, 5904 (2011)); this device's battery mode will be fully charged at 3.2 V which is in the range of 2.7-3.6 V as presented in 0@b and 0@c. In FIG. 2B(3), after lithium and Li-ion positive charge accumulation saturation at the negative electrode's surface, the Li-ions diffuse to the positive electrode electrolyte interface forming with Li-ion holes at the positive electrode's interface a new EDLC(b). In fact, during the Li-ion diffusion towards the positive electrode the electrolyte's internal resistance to charge transfer is overcome. This resistance can vary depending on the device's cycling. In FIG. 2B(4), it is presented an explanation for the device's discharge process. The electrolyte's Li-ions in the positive electrode EDLC(c) will receive the electrons transported via external circuit from the negative electrode which will reduce and react with sulfur, leaving vacancies at the inner surface of the positive electrode. When the positive electrode stops producing Li₂S, 4 to 21 wt % (depending on the device) of the positive electrode's sulfur will have been actively used during battery mode discharge. A EDLC(b) will be formed at the sulfur based electrode's interface with the Li-ions of the separator electrolyte and the vacancies of the electrode's electrolyte. On the negative electrode's side, oxidized carbon and/or the Li-ions that eventually remained after battery discharge will form another EDLC(a) with the Li-ions vacancies in the electrolyte (corresponding to a negative net charge).

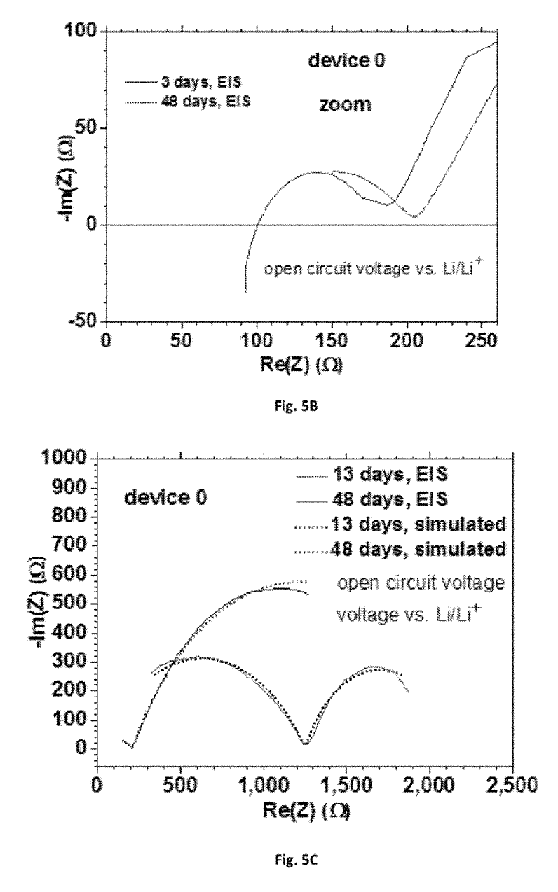

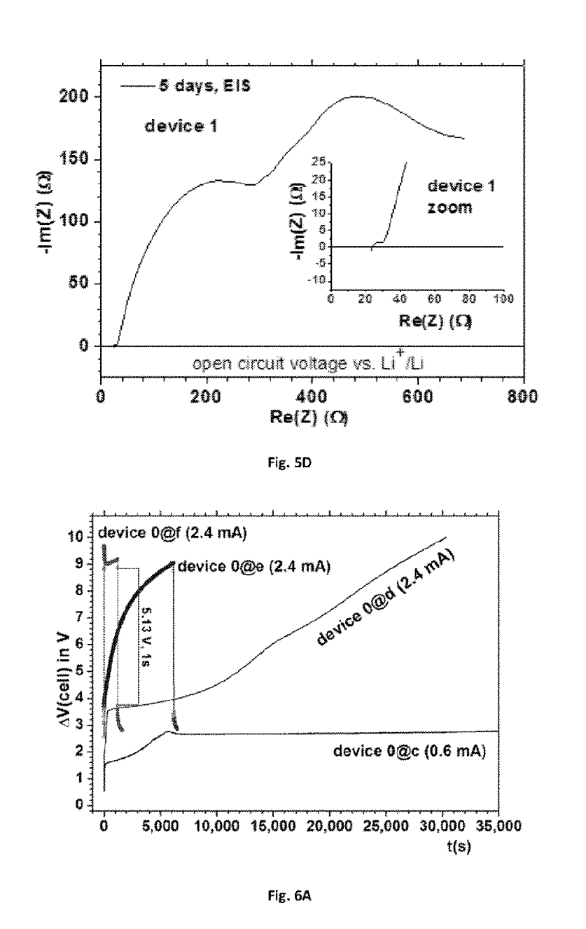

In FIG. 2A and FIG. 2C, it is observed that following the EDLCs burst discharge at Voc, the battery mode will start discharging at 2.89 V and after 19 h the device reaches a steady state at 1.4-1.2 V that will remain for more than 4 days and which is likely to be due to the formation of new EDLCs as shown in FIG. 2B(4). This extra capacity will be included in the battery mode calculations in this work for simplicity and to distinctively mark two discharging moments: one that takes 1 s and the other that can take up to days to discharge. FIG. 2D presents the galvanostatic charge/discharge of device 0@a at +1.2 mA as a function of the capacity. While discharging, the device quickly changes its polarity and starts charging after discharging. The total electrostatic energy for charge is 79 mWh and for discharge is 84 mWh, indicating that the device starts to charge after discharge. The process in which the EDLCs are charged during discharge is exactly the reverse in terms of polarity but very similar to the one described in FIG. 2B(3), as shown in FIG. 2B(5). The three capacitors in FIG. 2B(5) were observed in a EIS experiment with device 1 FIG. 5. In FIG. 2E to FIG. 2G, three different galvanostatic charge/discharge cycles of device 1 can be analyzed. In FIG. 2E the battery mode in device 1 is discharged at a negative voltage after initial burst at open circuit voltage. The internal resistance to charge transfer is similar to that observed on charge for both devices 0@a and 1@a (110 charge vs. 108 Ωdischarge for 0@a, FIG. 2D, and 42 Q charge/discharge for 1@a FIG. 2E). In FIG. 2F, it is observed that the saturation voltage of the EDLCs during the “discharge” at a negative constant current is very similar to that of charge. The latter is expected, since this voltage is dependent on the electrochemical window of stability of the electrolyte and of the impurities as mentioned previously.

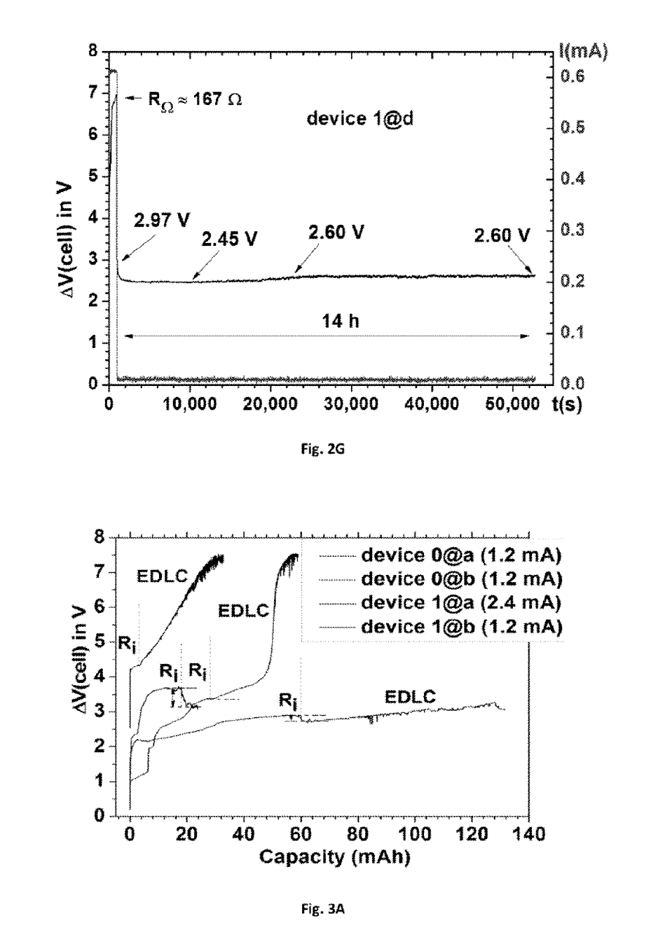

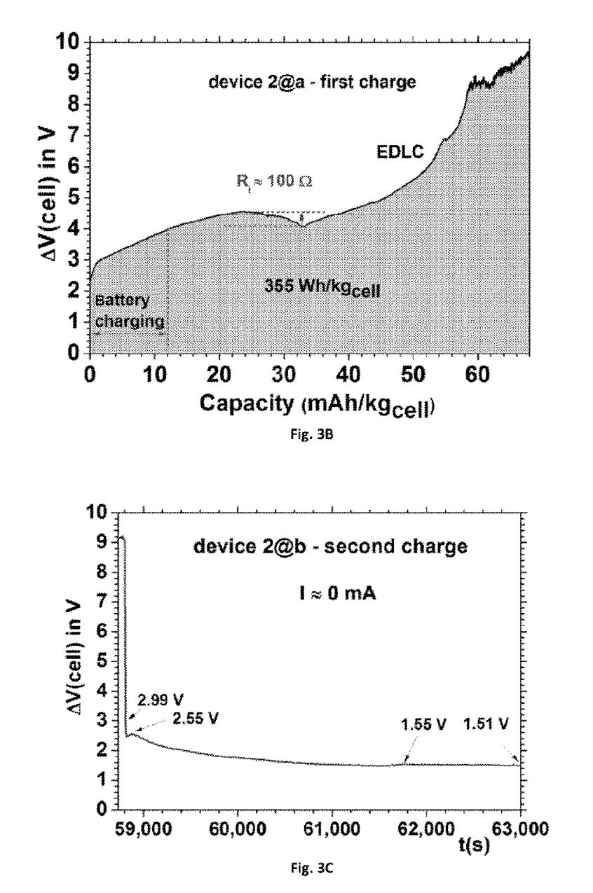

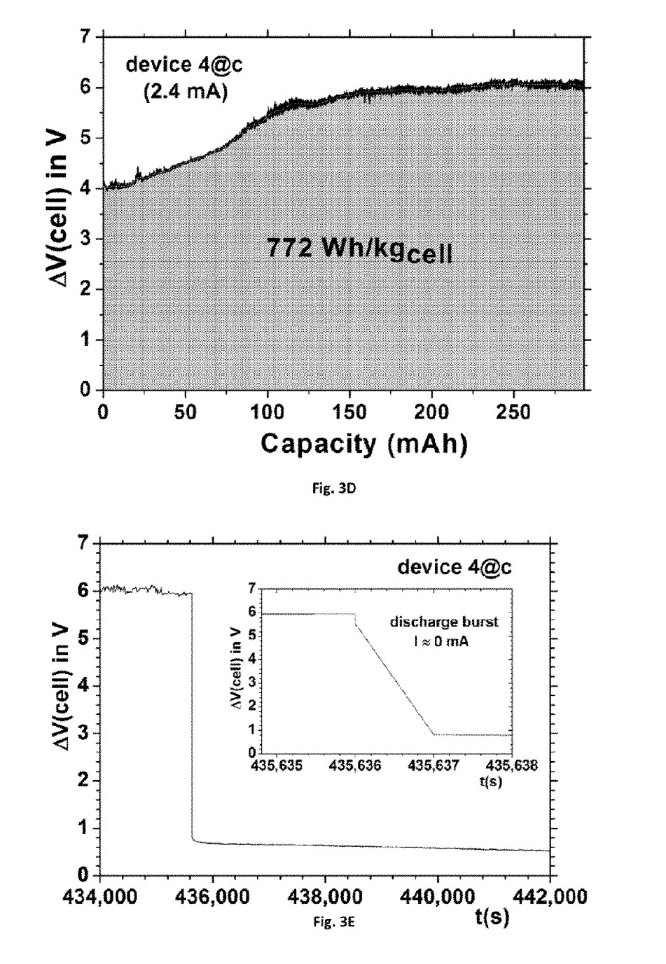

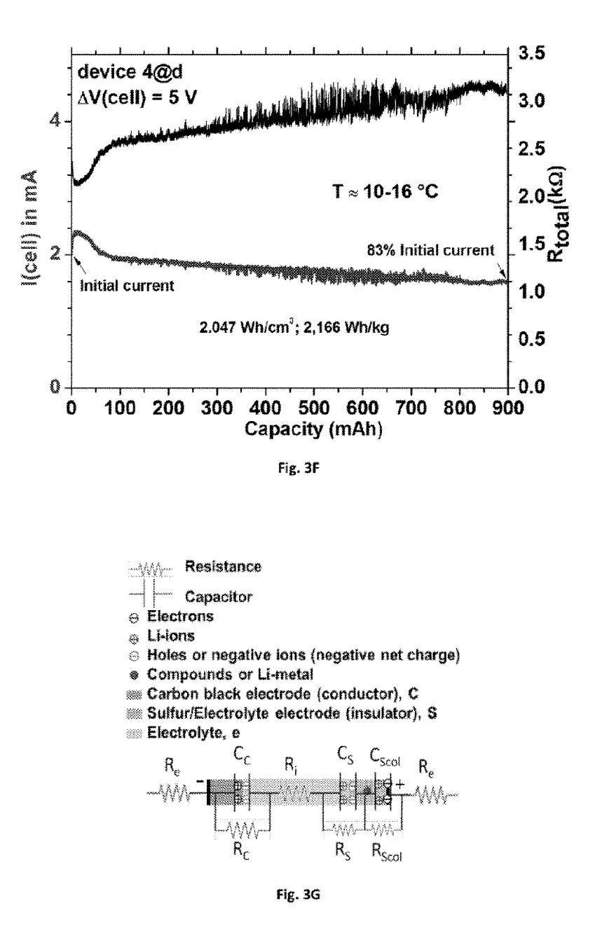

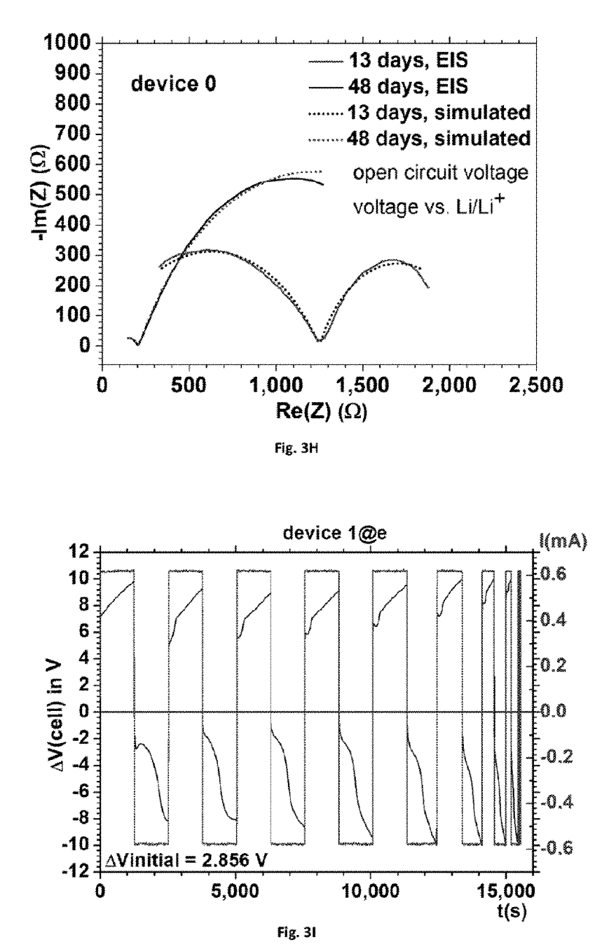

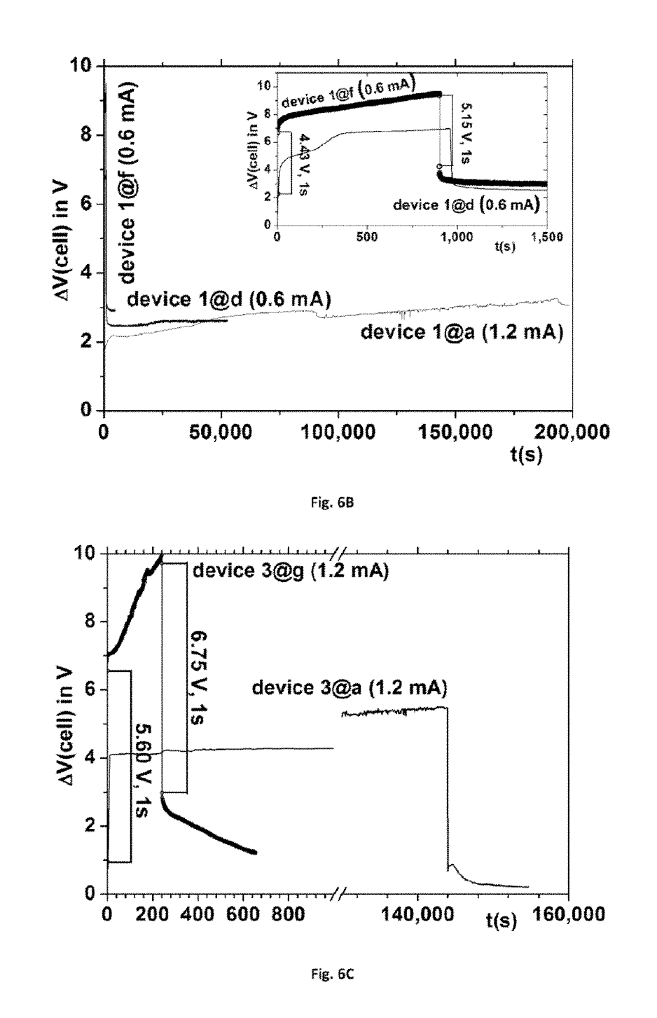

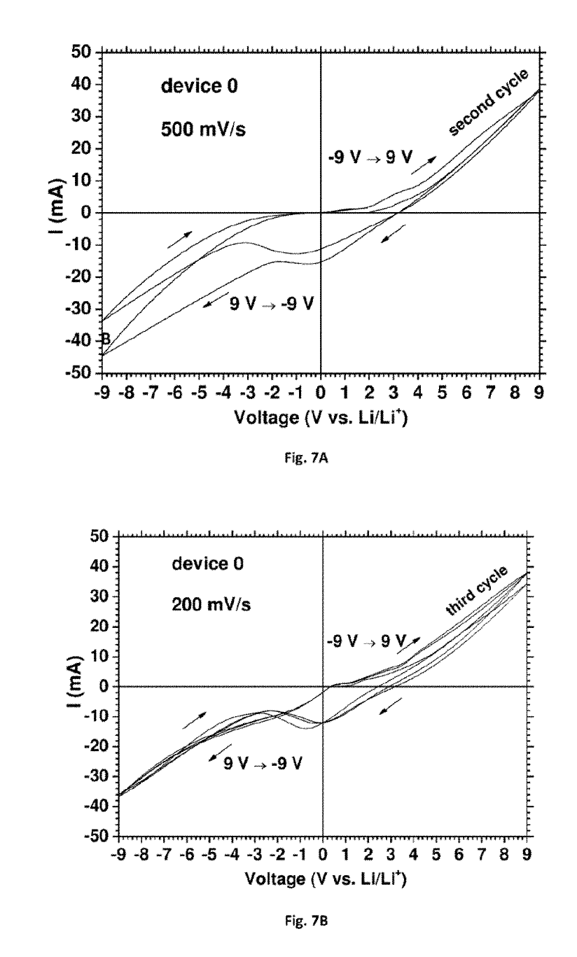

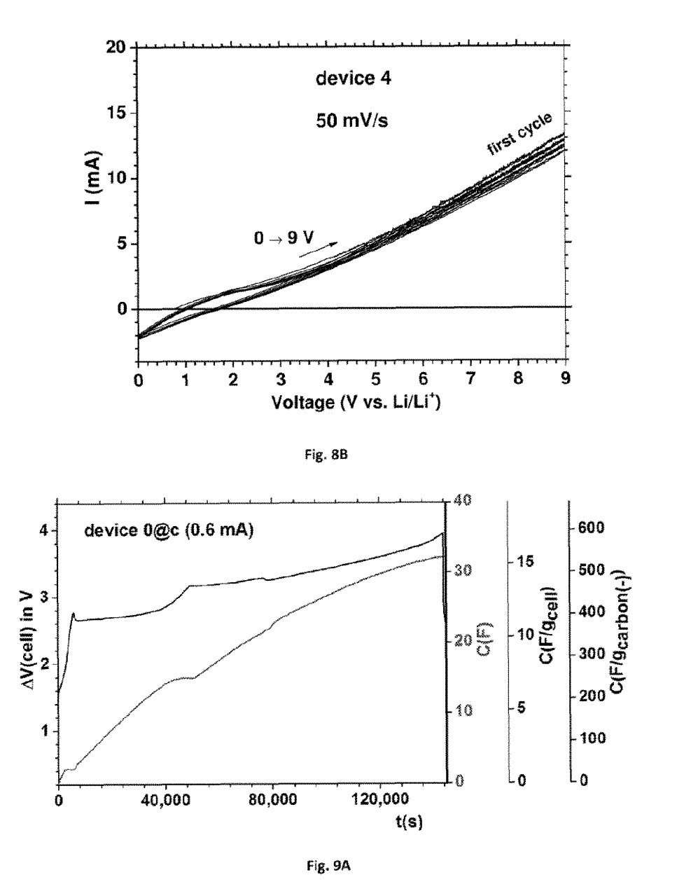

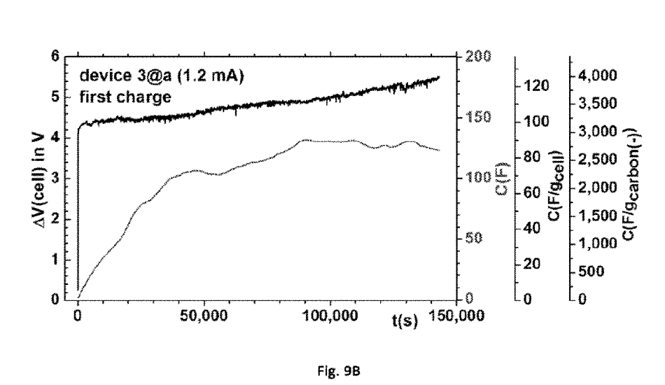

In an embodiment, FIG. 2G and FIG. 6 present other charge/discharge cycles of device 1. In FIG. 2G the device 1@d charges as a capacitor to 3.8 V in less than 10 s and to 5 V in 90 s. Discharge took place at I<0 mA. I n this experiment, it may be observed that the device did not discharge as a battery. A steady state was achieved with EDLCs formation corresponding to FIG. 2B(4). After 14 h, the cell's voltage was still 2.60 V. The Li—S battery characteristic discharge curve could not be observed conversely to what was observed in previous experiments. The ability to keep the battery mode charged seems to be inversely proportional to the percentage of Li-ions of the electrolyte in the positive electrode which is effectively used in battery mode discharge and which varies from 6%-device 1 to 33%-device 3. In FIG. 3A two consecutive charging processes of device 0 and 1 are shown (more in FIG. 6). It can be observed how the internal resistance drops from experiment a to b in both devices. After sufficient conditioning, not only does the electrolyte's internal resistance drop, but also the EDLCs charge transfer resistance. The EDLCs load up to 7.5 V in experiment b of both devices. FIG. 3B presents the charging process of device 2 during its first charge. The process is very similar to the charges shown for device 0 and 1. Nonetheless, the EDLCs maximum tolerance voltage is 9.0 V and the battery mode is fully charged at 4.0 V. FIG. 3C presents a zoom of the discharge of device 2@ b. It discharges from 9.1 V to 3.0 V in 1 s and subsequently starts discharging a remnant of the battery mode charged during experiment a (Voc prior to experiment b was 1.1 V). FIG. 3D presents the charge of device 4@c. The device does not seem to charge as a battery and immediately achieves 4.26 V. The capacitance shown during experiment c is very high, achieving 622 F. It is highlighted that the energy stored is 772 Wh/kg cell but the device could be kept charging since the correspondent voltage was 6 V. FIG. 3E presents the open circuit discharge of the device 4@c. The burst discharge takes 1 s or less and the device discharges almost completely (from 6 to 0.8 V) indicating that the device just performed in EDLC mode. The elevated value of energy stored and displaced charges facilitated full discharge at burst since highly dynamic processes were promoted. FIG. 3F shows the charge of device 4@d at a constant voltage of 5 V. The resistance can be calculated and is of the order of 2.2-2.75 kΩ. During the first part of the measurement, the resistance dropped from 2.5 to 2.1 kQ indicating self-organization leading to optimization of the cell, despite having four months of shelf-life and more than 300 cycles. The charge is extremely stable and the current never dropped to more than 80% of the initial current which indicates that the cell could have been further charged. Actually, the capacitance achieved in experiment 4@c was 622 F indicating that experiment 4@d could have been substantially extended. FIG. 3G presents the schematic representation of the equivalent circuit of the nearly discharged device corresponding to FIG. 2B(4). FIG. 3H and FIG. 8 present a comparative analysis of the conditioning process of device 0 through the variation of the capacitances and resistances measured by EIS at fabrication voltage. The charge transfer resistance of the EDLC(a) at the carbon electrode does not improve considerably with cycling. The capacitance of the latter EDLC(a) is of the order of the nF. At the positive electrode the EDLCs(b,c) capacitance is of the order of the mF after conditioning, which is six orders of magnitude higher than the corresponding of the negative electrode. However, during charge, the EDLC(a) increases its capacitance considerably and attains similar EDLCs (b,c) capacitance. The capacitance of the EDLC(b) will increase considerably with cycling (0.12 nF @3 days and no cycles, and 0.61 mF @48 days and 80 galvanostatic cycles). The capacitor formed by the Li-ions of the electrolyte in the sulfur based electrode and the electrons in the collector is not observed in device 0 in FIG. 3H but an EDLCs(c) is observed in device 1 in FIG. 5. FIG. 3I shows charge/discharge cycles performed on device 1 after experiments a to d. In the first cycles, the battery mode can be observed, especially at discharge. Alternatively, the last cycles only show evidence that the device only performs in capacitor mode.

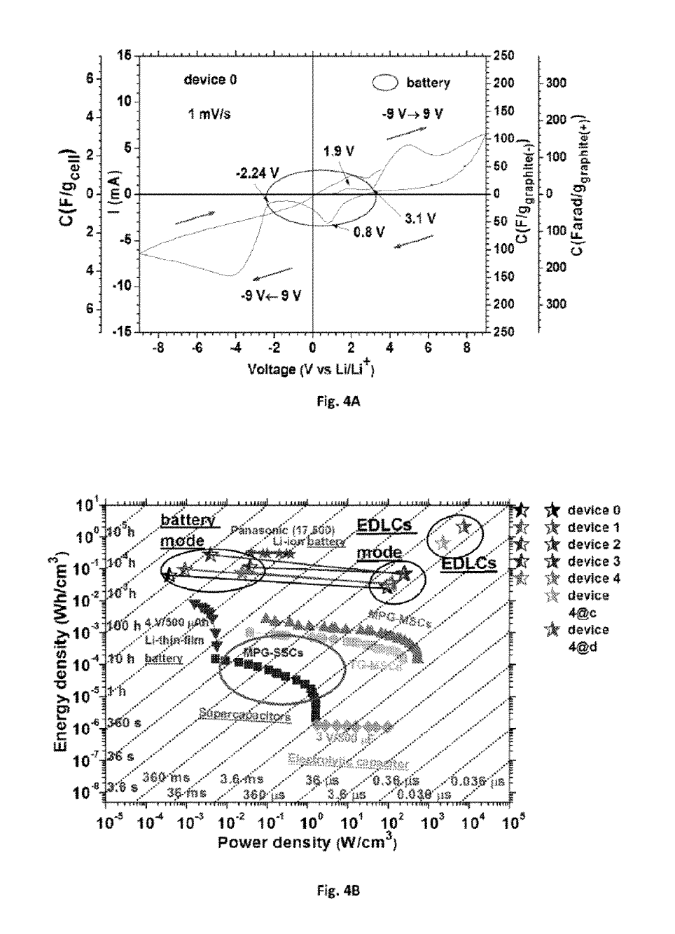

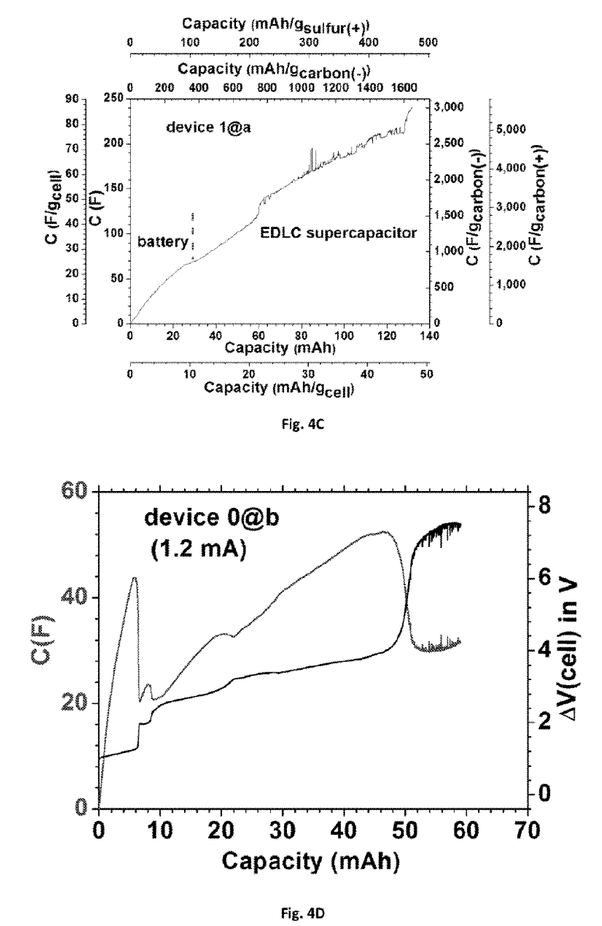

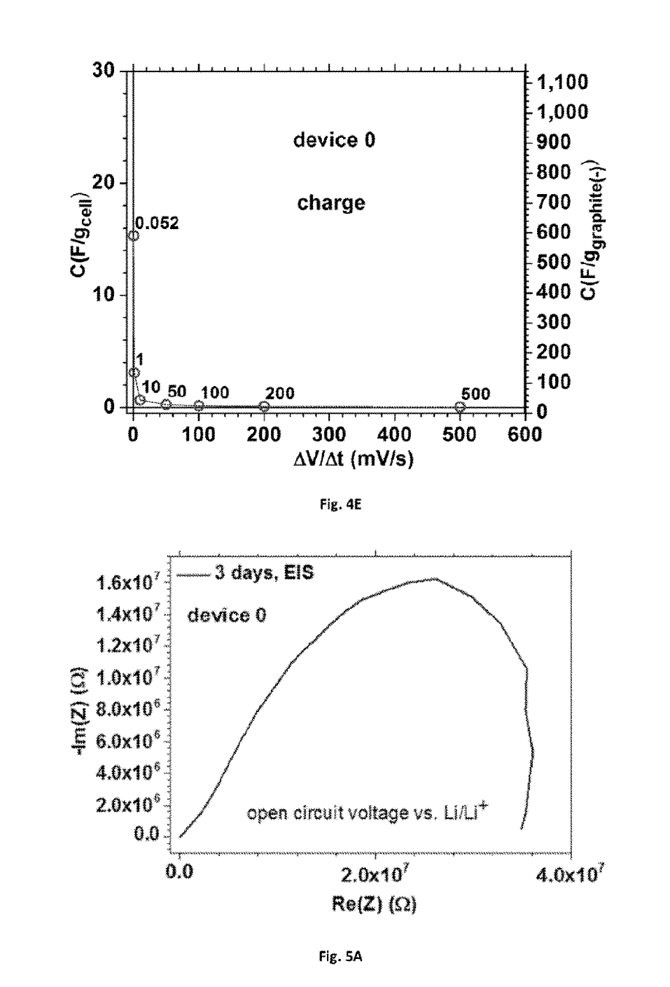

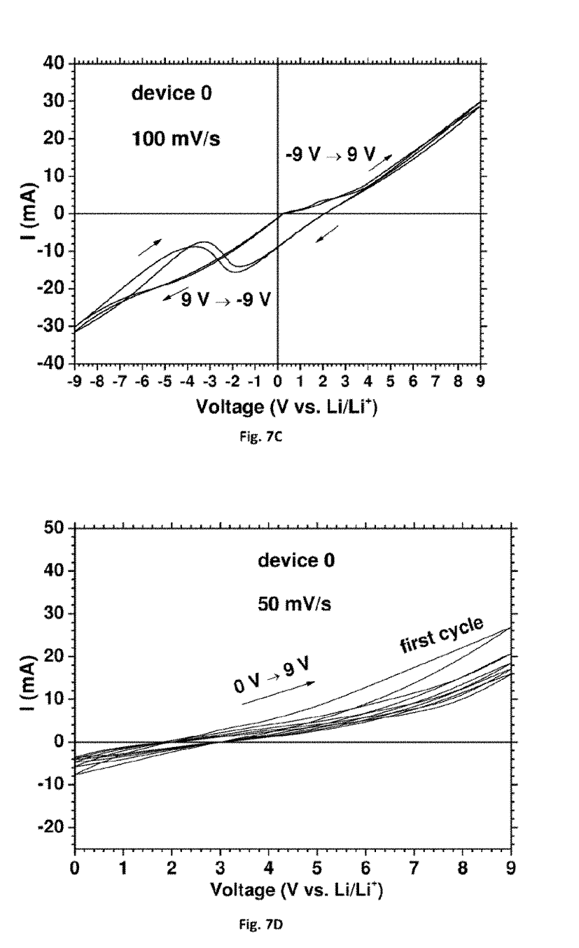

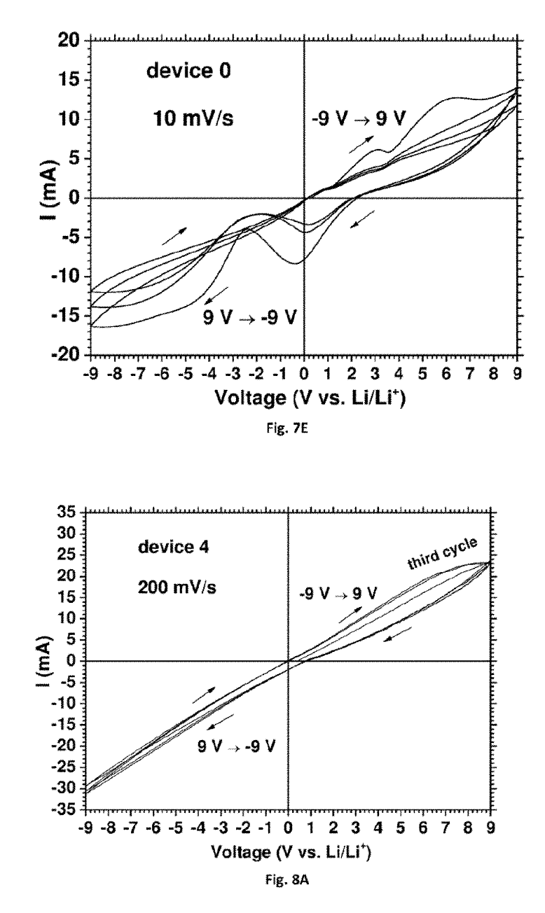

In an embodiment, FIG. 4A shows a cyclic voltammetry curve for device 0 at 1 mV/s (other CVs for device 0 and 4 in FIG. 7 and FIG. 8). This device shows the features of a Li—S battery between −2.24 and 3.1 V (Zheng, S. et al. J. High Performance C/S Composite Cathodes with Conventional Carbonate-Based Electrolytes in Li—S Battery. Sci. Rep. 4, 4842 (2014); Ji, L. et al. Graphene Oxide as a Sulfur Immobilizer in High Performance Lithium/Sulfur Cells, JACS, 133, 18522 (2011); Xie, J. et al. Preparation of three-dimensional hybrid nanostructure-encapsulated sulfur cathode for high-rate lithium sulfur batteries. J. Power Sources, 253, 55 (2014)). The charge of the carbon electrode at 3.1 V is observed as well as the discharge of the sulfur electrode at inverted polarity (−2.24 V). Outside this range, the features of a capacitor immerge. The pseudo-capacitance due to Faradic interactions at the carbon electrode are remarkable for a voltage between 4.2-6.2 V. The capacitance reaches 110 F/g carbon(−) and 160 F/g carbon(+). There are no visible Faradic interactions at the sulfur based electrode which is expected since the carbon(+) does not appear to play an active role and the Li-ions never cross this electrode. It should be highlighted that the hysteresis is especially reduced at high AV/At rates (FIG. 7 and FIG. 8). It is concluded that the reduced power loss in the capacitor mode is attributed to a small dielectric hysteresis and dielectric leak. If the—battery and capacitor mode—of an autonomous device are considered independently, then for example the EDLC in device 3 performs with a power density of 240 W/cm³ (157,000 W/kg) and an energy density of 0.0666 Wh/cm³ (56.9 Wh/kg) and the battery mode with power density of 0.0378 W/cm³ (32.3 W/kg) and energy density of 0.113 Wh/cm3 (96.9 Wh/kg) as represented on the Ragone plot in FIG. 4B. It is highlighted the performance of the EDLC mode of device 4@c. The supercapacitor mode of these devices can store more energy than any other known capacitor and the battery mode of most devices can store energy for more time than Li-ion batteries. For simplicity, it is considered the device to be in battery mode after the discharge burst although the EDLCs that charge in this mode contribute considerably to its discharge time, as previously discussed. FIG. 4C shows how the capacitor's capacitance varies as a function of the capacity in device 1@a. The first part of this capacitance increase is due to battery mode charge and the second due to the formation of EDLCs. A total maximum capacity of 1,650 mAh/g carbon(−) is achieved. A cell capacity of this magnitude is not due to the battery's electrochemistry (since graphite's theoretical capacity is 372 mAh/g). In the battery mode the maximum capacity achieved is 364 mAh/g carbon(−) (98% of the theoretical capacity); with the remaining capacity being attributed to the EDLCs. Conversely, sulfur is under-utilized since only 104 mAh/g sulfur of its theoretical maximum capacity of 1,670 mAh/g are used. Moreover, sulfur will only have an active role at the battery mode level of device 1 corresponding to ˜6% of its maximum capacity, which is in agreement with the overall battery reaction (the percentage of the sulfur actively used was 4-8% for devices 0, 1, 2, and 4 and 21% for device 3). The capacitance at the negative electrode of device 1@a will increase to a maximum of 674=1,550-876 F/g carbon(−) after battery charge and during Li-ion accumulation at the negative electrode. The capacitance corresponding to the EDLCs(b,c) FIG. 2B(3), is gained after overcoming the internal resistance of the electrolyte. The cell's capacitance reached a maximum of 90 F/g cell and 3,000 F/g carbon(−). FIG. 4D provides insight into the charging mechanism. Up to 1.26 V the EDLCs form as suggested in FIG. 2B(1) and the maximum capacitance is 43.8 F. Then the battery starts to charge FIG. 2B(2) and the capacitance drops to 20.4 F which corresponds to approximately half of the previous capacitance due to a half drop in charge accumulated at the equivalent capacitor for the same voltage. At the cell level, the capacitance actually decreases due to a sudden voltage increase, at approximately constant charge, owing to charge diffusion towards the negative electrode. Then the capacitance will increase again due to battery mode charge. During the latter charge, the EDLCs(b,c) remain charged. When C=32.6 F, the battery is charged. The capacitance will increase again up to 39.4 F due to charge accumulation at the negative electrode (the voltage remains approximately constant), moment at which the negative electrode becomes a LIC electrode. The Li-ions reverse direction when charge accumulation at the negative electrode saturates and reversely charged EDLCs form at the surfaces. Prior to this latter inversion of Li-ion diffusion direction, the capacitance step-increases due to a drop of voltage corresponding to the internal resistance to charge transfer. The maximum capacitance C=52.5 F is reached at 4.0 V (which corresponds to all the capacitors charged, approx. 40.0 F, plus the battery contribution, 12.5 F. Then the capacitance starts decreasing. It drops down to 30.0 F at V=6.9 V. This drop of capacitance is eventually due to Faradic interactions at the carbon electrode, which result in capacitor's discharge. This effect is also observed in CV of FIG. 4A during charge for 5.00 V<Voltage<6.45 V. FIG. 4E shows the behavior of the capacitance with the voltage rate (AV/At). For more capacitance analysis in devices 0 and 3, FIG. 9.

In an embodiment, it is disclosed devices that are safe, environmentally friendly and inexpensive. The present devices are both supercapacitors and batteries. The switching between the two modes on charge and discharge is autonomous. The EDLCs important discharge takes place in 1 s or less. It is likely that other EDLCs are formed at discharge which proportionate a delay of the battery mode discharge. Moreover, it was observed that it is possible to charge the devices during galvanostatic discharge. The present devices, working in battery mode, are uniquely lithiated from the Li present in the electrolyte; in effect, the sulfur at the positive electrode will only react with the Li-ions of the electrode's electrolyte protecting the electrodes interface and avoiding polysulfide shuttle. The Li-ions never cross this latter surface even during battery mode discharge. It was never observed a substantial variation of the device's temperature while running experiments (a maximum of 0.5° C. at 9V). The charge transfer resistance of the EDLCs at the positive electrode decreases considerably with cycling, possibly revealing self-assembling and self-healing at the nanoscale. Several devices performed more than 100 cycles and sustained a shelf life of three months while still performing as battery, besides supercapacitor. In fact, these devices benefit considerably with conditioning. It will be possible to tailor these devices by changing relative compositions, and by optimizing each component of the device. The capacitor or battery mode properties will depend on the previous parameters and therefore will be adapted in view of an application.

In an embodiment, the devices 0-4 previously discussed, are of the same family here described and only differ in weight, amount and thickness of positive, negative electrodes/collectors and electrolyte and or surface area.

### Na-Ion Compositions and Devices

The present disclosure relates to the development and improvement of sodium-ion electrochemical devices, in particular to the development of a new device; a supercapacitor and a supercapacitor and battery solid carbon-sulfur Na-ion based device with autonomous dual functionality which is charged from the Na-rich glassy electrolyte solid electrolyte glass comprising a safe, environmentally friendly and inexpensive device. The present dual mode of operation, both a high energy battery mode and power capacity supercapacitor mode along with a burst discharge of less or equal to 1 second. In the supercapacitor mode of a device, it can store more energy than any other known capacitor and in the battery mode several of the present devices stored more energy for a longer period than most Na-ion batteries.

Here it is presented an energy storage cell with two energy storage modes which can operate as a supercapacitor or a supercapacitor and sodium battery (Song, H. K., Lee, K. T., Kim, M. G., Nazar, L. F., Cho, J., Recent progress in nanostructured cathode materials for lithium secondary batteries. Adv. Fund. Mater. 20, 3818 (2010); Palomares, V., Serras, P., Villaluenga, I., Hueso, K. B., Carretero-Gonzalez, J., Rojo, T., Na-ion batteries, recent advances and present challenges to become low cost energy storage systems. Energy Environ. Sci. 5, 5884 (2012); Ellis, B. L., Nazar, L. F., Sodium and sodium-ion energy storage batteries. Curr. Opin. Solid State Mater. Sci. 16, 168 (2012)). This device will impact a very broad spectrum of applications especially in the transportation, grid stationary, and aerospace.

In an embodiment, the present disclosure relates to a supercapacitor and battery solid carbon-sulfur Na-ion based device with autonomous dual functionality and charged from the Na-rich glassy electrolyte.

In some cases, the collectors can have a predominant role. They can function as electrodes being the copper+carbon black the positive electrode and the sulfur+glass electrolyte+carbon in aluminum the negative electrode. This configuration makes the device works reversely to what was described for charge and discharge.

A supercapacitor and battery solid carbon-sulfur Na-ion based device with autonomous dual functionality which is uniquely charged from the Na-rich glassy electrolyte is now disclosed. Unlike the molten salt battery, Na—S, constructed from liquid sodium and sulfur, which operates at temperatures of 300 to 350° C. and generates highly corrosive sodium polysulfides, and therefore primarily suited to large-scale non-mobile applications such as grid energy storage; the devices now disclosed are environmentally friendly and inexpensive and so not present any of the previous cited risks of molten Na—S batteries. They operate at room temperature and do not exhibit any polysulfides ‘shuttle’ problems associated with this chemistry, and therefore these devices have a prolonged cycle life. They present a dual mode of operation, both a high energy battery mode and a power capacity supercapacitor mode along with a burst discharge of one (1) second.

In the supercapacitor mode of a device, it can store more energy than any other known capacitor and in the battery mode, the devices now disclosed stored more energy for a longer period than most Na-ion batteries. The devices now disclosed are safe and therefore will have numerous advantages in a multitude of markets such as mobile applications and grid energy storage.

A supercapacitor and battery solid carbon-sulfur Na-ion based device with autonomous dual functionality and charged from the Na-rich glassy electrolyte are now disclosed.

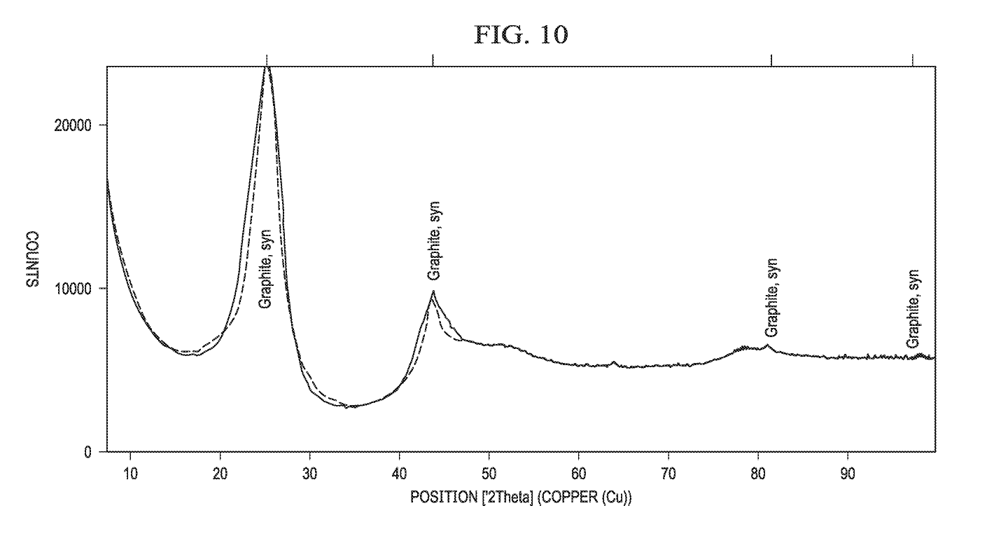

This disclosure presents a solid state bulk energy storage device working autonomously, simultaneously or independently as a supercapacitor and as a battery; although predominantly as a supercapacitor. On charge, the supercapacitor is the last mode to be fully charged and on discharge, the supercapacitor mode is the first to be discharged. The device is composed of a copper bulk collector, a negative electrode of carbon black (C) which is mostly disordered graphite (FIG. 10), a doped glassy electrolyte Na₃ClO based, a positive electrode comprised of a mixture of: sulfur (Ss), a glassy electrolyte, and carbon black, deposited on an aluminum bulk collector. If some sulfur reacts with the electrolyte, during electrode preparation, it is most likely just at the surface forming an amorphous phase that cannot be distinguished from the other amorphous phases already present (glassy electrolyte and carbon black, FIG. 10). The surface dimensions of the cells' electrodes are 2.5×2.5 cm² with a loading of 0.20-0.40 g/cm² of electrode materials and electrolyte. The sulfur loading can be 0.018-0.040 g/cm². Collectors have an extended functionality; besides being an electronic transport media, they have a support and heat dissipation functionality which is not intrinsic to the device. The cells have 0.15-0.35 g/cm² of electrolyte as separator. The cell's thickness is 0.15-0.35 cm. The electrodes, electrolyte and collectors were accountable to the device's weight.

A glassy-electrolyte of the same family, Li₃ClO, was previously characterized (Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014)).

The Na₃ClO based glassy electrolyte's high ionic conductivity enables the fabrication of solid state energy devices with bulk (thick) layers of electrolyte, enabling existing battery coating methods. The Na-rich transport characteristics of the electrolyte permit enhanced cell component kinetics and increased life cycle. Moreover, the battery mode is charged/discharged from the electrolyte and in the sulfur based electrode the Na-ions do not cross the electrode's surface allowing for a new set of electrode combinations such as the carbon-sulfur pair presented herein. The open circuit's voltage at the time of cell fabrication, is lower than 0.1 V permitting for extremely safe transportation and storage. Consequently, the device can be charged at the destination as battery or/and supercapacitor.

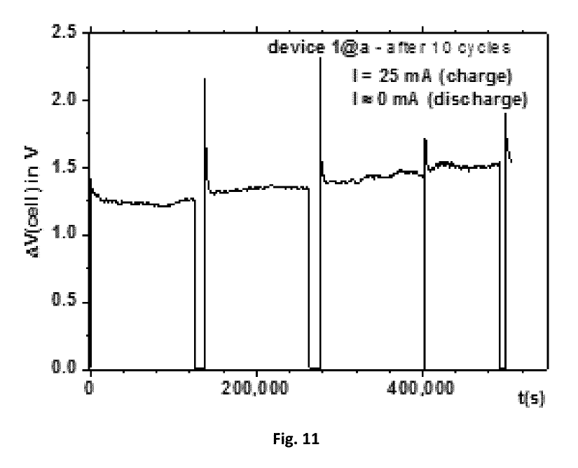

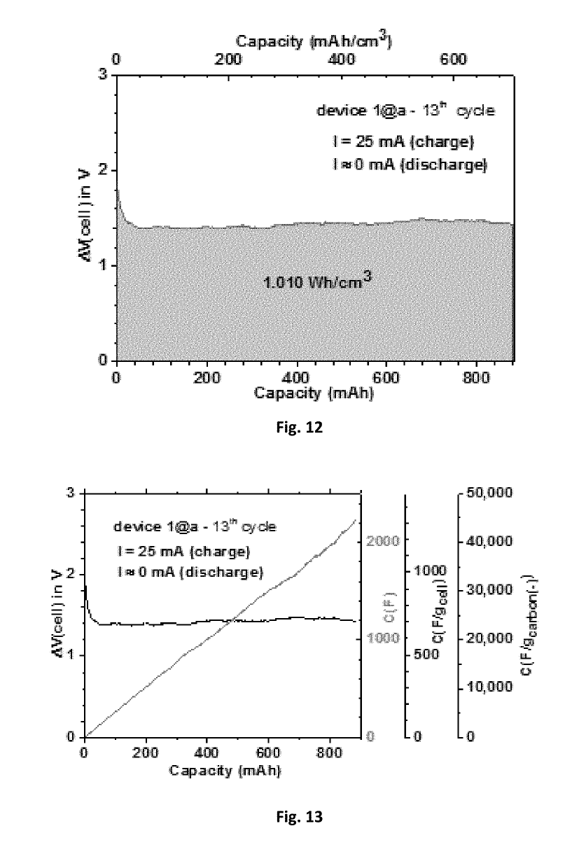

The galvanostatic charge/discharge cycles for the carbon(C)/electrolyte/sulfur based(S)-device 1@a are shown in FIG. 11, at a charging current of 25 mA, 15 mA/g cell and discharging at an open circuit. The EDLCs within device 1@a begin to charge at Δν=1.4 V and the EDLC mode is the only mode charged in all the curves in FIG. 11 and FIG. 12. This latter observation is reinforced by analyzing the device's discharge data; the device discharges to 0 V, not presenting any battery mode discharge. It is highlighted the high capacity and energy density that can be reached with device 1 shown in FIG. 13. The super capacitance exhibited: 2,230 F; 1,320 F/g cell and 44,800 F/g carbon(−) (in the negative electrode) is another characteristic of these devices that will allow numerous practical applications.

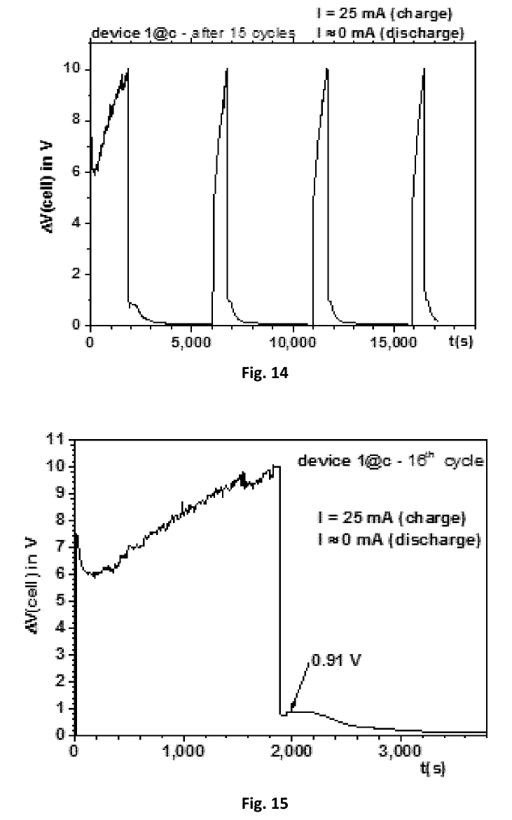

In FIG. 14 and in the zoom in FIG. 15 the cell voltage reached is much higher and the device starts charging at 7.6 V, although it drops to 6 V subsequently to increase to 10 V afterwards. From 6-10 V the voltage increase tends to linearity. It is believed that in these cycles there is a battery mode charge/discharge corresponding to the overall stoichiometric

$$( \frac{1}{8} {S}_{8} + 2 {NaC}_{6} {}_{discharge} {Na}_{2} S + 2 {C}_{6} )$$

corresponding to a Gibbs energy of ΔG≈−376 kJ/mol (corresponding to a cell voltage of 1.95 V at 298 K) and a theoretical capacity of 372 mAh/g_{carbon(-} governed by the carbon electrode

$$( {NaC}_{6} {}_{discharge} {Na}^{+} + \overline{e} + {C}_{6} ) .$$

It can be discharge observed in all the discharges shown in FIG. 14 a hump after burst discharge that does not exceed 0.91 V. Although the expected battery mode discharging voltage is 1.95 V at 298 K. The value of x in

$${Na}_{x} {C}_{6} {}_{discharge} {xNa}^{+} + x \overline{e} + {C}_{6}$$

corresponding to an overall reaction

$$( \frac{x}{8} {S}_{8} + 2 {Na}_{x} {C}_{6} {}_{discharge} {x Na}_{2} S + 2 {C}_{6} )$$

and of the irreversibility percentage was previously described by (Yabuuchi, N., Kubota, K., Dahbi, M., Komaba, S., Research Development on Sodium-Ion Batteries. Chem. Rev. 114, 11636 (2014)).

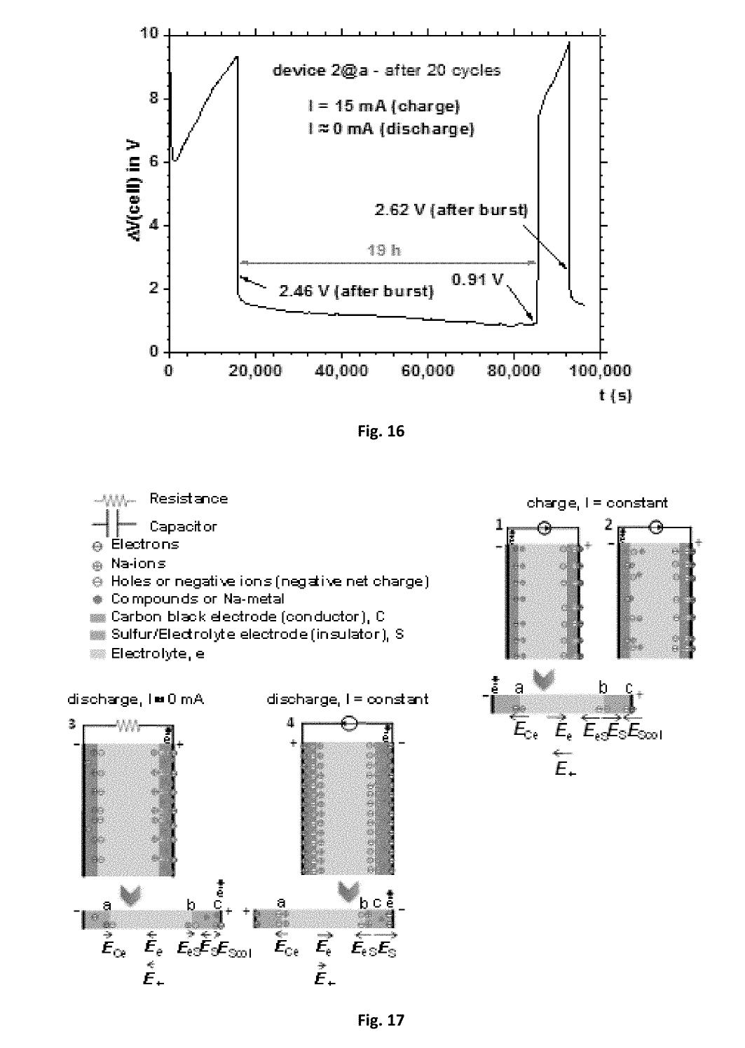

FIG. 16 shows charge/discharge cycles for device 2@a. In experiment a, after 20 cycles, this device shows a very similar behavior to device 1@c, after 15 cycles. While the charging current for device 1@c was 25 mA, 15 mA/g, for device 2@a was 15 mA, 8 mA/g. The discharge is essentially different. Device 1@c shows a hump at 0.91 V, device 2@a shows a flat voltage after burst discharge that is observed at 2.46 V and that decreases to 0.91 V during the first cycle of the experiment. It is not very clear if there is a small hump at 0.91 V as in device 1@c, but the first part of the discharge, after burst, seems to be due to the formation of the EDLCs, as will be subsequently explained.

FIG. 17 shows the current explanation for the physical and chemical processes in the device during galvanostatic charge and discharge. In FIG. 17(1), at the carbon electrode and after the electron conduction and their accumulation at the surface, an EDLC(a) is formed with the separator electrolyte's Na-ions accumulating at the interface. This process leaves Na-ions holes (vacancies) on the opposite surface of the separator electrolyte (at the positive electrode interface), which correspond to a negative net charge. At the sulfur based electrode, 46 wt % of the electrode is comprised of the sodium-rich electrolyte whose Na-ions accumulate at the surface. These Na-ion vacancies within the separator electrolyte, constitute the EDLC(b) at the positive electrode's interface. At the electrode/collector interface another EDLC(c) forms from the Na-ion vacancies on the sulfur based electrode and the positive ions at the Al collector. FIG. 11 presents charge curves that seem to be in agreement with the FIG. 17(1) charging process.

In FIG. 17(2), the Na-ions of the electrolyte at the carbon electrode initiate diffusion into the electrode. The inbound ions within the carbon electrode will be reduced by the electrons and NaₓC₆ will be formed. The carbon electrode, which is composed of amorphous carbon, determines the battery mode's maximum capacity has referred previously. The charge of the battery mode is not clear in the performed experiments since the EDLCs are always present during charge. However, the discharge data, indicates that battery charge took place within the Li-devices.

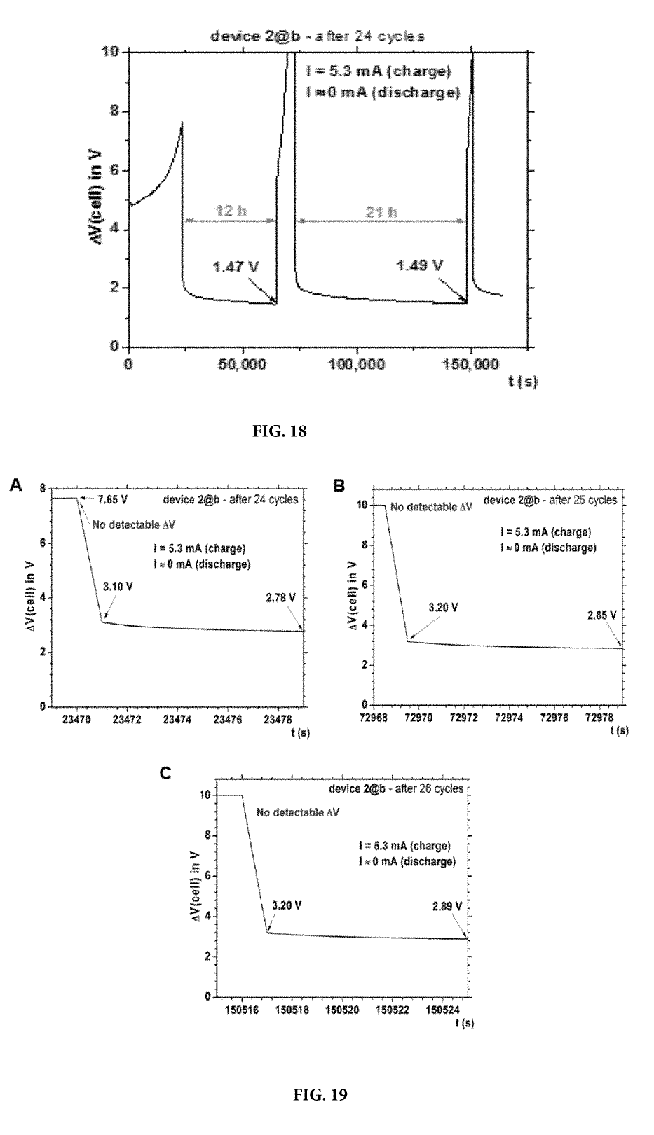

In FIG. 17(3), it is presented an explanation for the device's discharge process. The electrolyte's Na-ions in the positive electrode EDLC(c) will receive the electrons transported via external circuit from the negative electrode which will reduce and react with sulfur, leaving vacancies at the inner surface of the positive electrode. A EDLC(b) will be formed at the sulfur based electrode's interface with the Na-ions in the separator electrolyte and the vacancies of the electrode's electrolyte. On the negative electrode's side, oxidized carbon and/or the Na-ions that eventually remained after battery discharge will form another EDLC(a) with the Na-ions vacancies in the electrolyte (corresponding to a negative net charge). In FIG. 15, it is observed that once the EDLCs have burst discharged at Voc, the battery mode will begin discharging. In FIG. 18 and FIG. 19, after burst discharge, the battery mode starts its discharge at ˜3 V and the device reaches a steady rate of 1.5 V after 12 or 21 hours of discharge. This second and long discharge mode is defined as the battery mode, it can include battery and additional EDLCs formations, as shown in FIG. 17(3).

In FIG. 19 conversely to what would be observed with Li-devices, there is no visible Δν loss at discharge corresponding to the internal resistance. The resistance in Na-devices is usually an order of magnitude lower than in Li-devices.

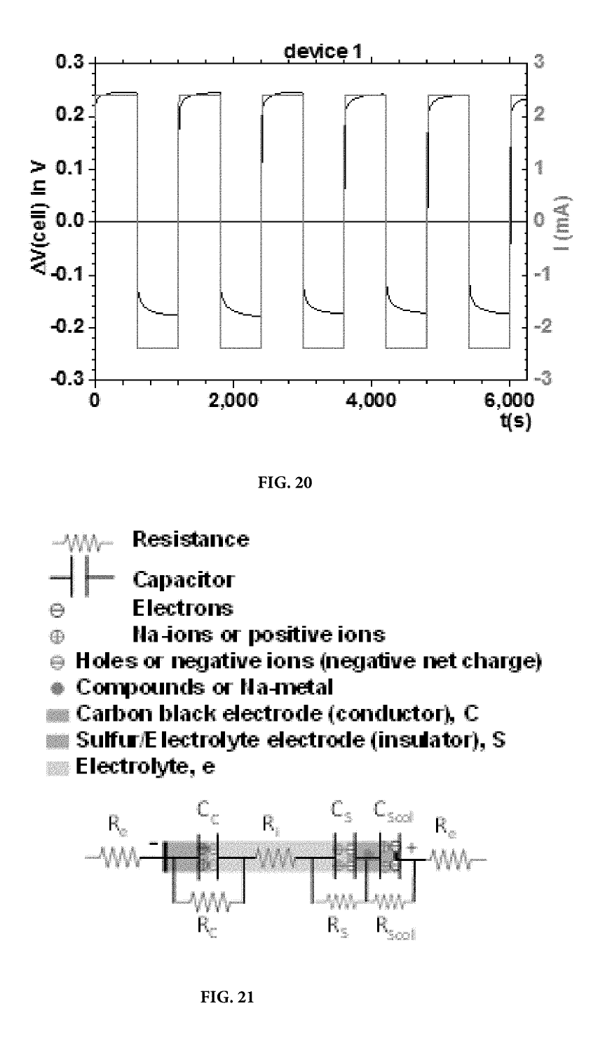

The polarization inversion in FIG. 17(4) occurring during galvanostatic discharge at negative current is observed in a charge/discharge experiment with device 1, presented in FIG. 20.

It is highlighted the performance of the EDLC mode in device 1@a. The supercapacitor mode of these devices can store more energy than any other known capacitor. For simplicity, it is consider the device to be in battery mode after the discharge burst although the EDLCs that charge in this mode contribute considerably to its discharge time, as previously discussed.

The present disclosure relates to devices that are safe, environmentally friendly and inexpensive. The present devices are both supercapacitors and batteries. The switching between the two modes on charge and discharge is autonomous. The EDLCs important discharge takes place in less than or in 1 second. It is likely that other EDLCs are formed at discharge which proportionate a delay of the battery mode discharge. Moreover, it was observed that it is possible to charge the devices during galvanostatic discharge. The present devices, working in battery mode, are uniquely charged/discharged from the Na present in the electrolyte; in effect, the sulfur at the positive electrode will only react with the Na-ions of the electrode's electrolyte protecting the electrodes interface and avoiding polysulfide shuttle. The Na-ions never cross this latter surface even during battery mode discharge. No substantial variation of the device's temperature was observed while running experiments (a maximum of 0.5° C. at 9V). The devices performed more than 30 cycles and sustained a shelf life of five months. It will be possible to tailor these devices by changing relative compositions, and by optimizing each component of the device. The capacitor or battery mode properties will depend on the previous parameters and therefore will be adapted in view of an application.

The present device is a combined EDLCs and carbon-sulfur (C—S) battery cell with a superionic sodium-rich doped Na₃ClO based glassy electrolyte. In order to properly characterize the cell, two identical devices for study under different testing conditions were fabricated. These devices' in their battery modes, are charged from the high sodium content in the solid electrolyte, the only material initially containing sodium ions. Each storage device is sequentially charged as an EDLC and battery and then finally as an EDLC. This order is reverted during discharge. It is an autonomous switching dual functioning device, which can present a device voltage of 9-10 V (once the supercapacitor is fully charged). In supercapacitor mode, one device has been measured as an EDLC with a power density of 3,636 W/cm³ (2.68×10⁶ W/kg cell) for an energy density of 1.010 Wh/cm³ (746 Wh/kg cell), corresponding to a discharge time of approximately 1 s (burst C-rate=3,168 C for a discharge current of 2,788 A).

In an embodiment, the present disclosure relates to a supercapacitor and battery solid carbon-sulfur Na-ion based device with autonomous dual functionality and charged from the Na-rich glassy electrolyte.

The present disclosure relates to a layered electrochemical solid device comprising a positive electrode current collector, a positive electrode, a glass electrolyte, a negative electrode and a negative electrode current collector wherein the positive electrode current collector comprises aluminum; the positive electrode comprises sulfur, a glass electrolyte of formula Na₃₋₂ₓMₓHalO or Na₃₋₃ₓMₓHalO and carbon; the glass electrolyte composition comprising a compound of formula Na₃₋₂ₓMₓHalO or Na₃₋₃ₓMₓHalO wherein: M is selected from the group consisting of boron, aluminum, magnesium, calcium, strontium, barium; Hal is selected from the group consisting of fluoride, chloride, bromide, iodide or mixtures thereof; X is the number of moles of M and 0<x<0.01; the negative electrode comprises a carbonaceous material; the negative electrode current collector comprises copper.

In an embodiment, said layered device electrochemical solid device comprises a positive electrode current collector, a positive electrode, a glass electrolyte, a negative electrode and a negative electrode current collector in which the collectors may additionally be electrodes being the copper the positive electrode and the aluminum the negative electrode.

In some cases, the collectors can have a predominant role. They can function as electrodes being the copper+carbon black the positive electrode and the sulfur+glass electrolyte+carbon in aluminum the negative electrode. This configuration makes the device works reversely to what was described for charge and discharge. In conclusion, when the role of the collectors is preponderant, they may overcome the role of the electrodes, reversing the functions of the electrodes and leading to a device with inverted electrodes.

In an embodiment, the positive electrode of the above-mentioned layered electrochemical device may comprise 3-80% (w/w) of sulfur, in particular 30-50% (w/w) of sulfur; 3-80% (w/w) of the electrolyte composition described previously, in particular 30-50% (w/w) and less than 20% (w/w) of a carbon, in particular less than 10% (w/w) of a carbon.

In an embodiment for better results, X may be 0.002, 0.005, 0.007 or 0.01.

In an embodiment for better results, Hal may be mixture of chloride and iodide, or chloride and bromide, or fluoride and iodide.

In an embodiment Hal may be a mixture of chloride and iodide, in particular for better results Hal may be 0.5 CI+0.5 I.

In an embodiment for better results, said electrodes may be suitable to be charged with Na-ions from the electrolyte.

In an embodiment for better results, the carbonaceous material of the negative electrode of the layered electrochemical device may be selected from the group consisting of carbon black, graphite, graphene, carbon nanotubes, spongy carbon, carbon foam, carbon white, carbon composite, carbon paper, carbon fibers, carbon film, printed carbon, and mixtures thereof.

In an embodiment for better results, the aluminum of the positive electrode current collector of the layered electrochemical device may be selected from the following list: an aluminum foam, aluminum film, aluminum foil, aluminum composite, aluminum wires, aluminum surface, or mixtures thereof.

In an embodiment for better results, the copper of the negative electrode current collector of the layered electrochemical device may be selected from the following list: a copper foam, copper thin film, copper foil, copper composite, copper wires, copper surface, other engineered form of copper, or mixtures thereof.

In an embodiment for better results, the positive electrode may further comprise an alcohol, an organic solvent, a polymer, or mixtures thereof, preferably the alcohol may be ethanol, methanol, or mixtures thereof; more preferably the alcohol may be absolute methanol, absolute ethanol, or mixtures thereof.

In an embodiment for better results, the layered electrochemical device now disclosed may further comprise a confinement, protection or wrapping immersement, said confinement, protection or wrapping immersement may by a polymer or a resin. Preferably, said polymer may be a water-proof polymer, or a water-resistant polymer, or a flexible polymer, or a rigid polymer, or a non-flammable polymer; or said resin may be an epoxy resin.

The present disclosure also relates to a capacitor comprising the layered electrochemical solid device now disclosed and described.

Furthermore, the present disclosure also relates to a battery comprising the layered electrochemical solid device now described.

The present disclosure further relates to a dual mode battery comprising the layered electrochemical solid device.

Another aspect of the present disclosure further relates to an electrical actuator comprising the layered solid electrochemical device now described.

Another aspect of the present disclosure also relates to a sonar comprising the layered electrochemical solid device now described.

Another aspect of the present disclosure also relates to a transducer comprising the layered electrochemical solid device now described.

### Examples

### Example 1: Li-Based Compositions and Devices

In an embodiment of synthesis of the glassy electrolyte Li_{3-2*0.005}Ba_{0.005}ClO was prepared from the commercial precursors LiCl (Merck >99% for analysis), LiOH (Alfa Aesar 98.0%) and Ba(OH)₂.8H₂O (Merck 98.5%) as described in (Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014)). After synthesis the electrolyte was heated to 250° C. for one hour and then cooled down, avoiding contamination with water from the air's moisture. A slurry was then prepared by grinding the electrolyte in ethanol (Merck 99.9% absolute for analysis). The slurry was protected in an Ar atmosphere.

In an embodiment the positive electrodes were prepared by adding sulfur, Ss, (Alfa Aesar Powder 99.9995% Puratronic) to the above prepared electrolyte (before mixing it with ethanol) and to carbon black (TIMCAL super C65) in a 47:46:7 weight ratio. The carbon black's XRD (FIG. 1A) shows the presence of graphite and amorphous carbon, probably denoting grains with an external crystalline layer and an amorphous inner phase. This mixture was grinded in ethanol (Merck 99.9% absolute for analysis). There were no prior perceptible reactions between the sulfur, the electrolyte and the graphite as presented in the XRD in FIG. 1B. The slurry was deposited on an Aluminum (Al) collector foil (Alfa Aesar Foil 99.45% 0.025 mm thick) with 2.50×2.50 cm² or 2.50×3.45 cm² and let dry at approximately 100° C. for 30 min (corresponding to 40-80 mg/cm² of positive electrode). The electrolyte's slurry was deposited on the top of the positive electrode and let dry for approximately 100° C. for 30 min (corresponding to 100-300 mg/cm² of electrolyte).

In an embodiment, the negative electrode was prepared by mixing carbon black from TIMCAL super C65 with ethanol (Merck 99.9% absolute for analysis) in a 12:88 weight ratio. The resulting slurry was deposited on a copper (Cu) collector foil (Alfa Aesar Foil 99.8% 0.025 mm thick) and let dry for about 10-20 min at 100° C. (corresponding to 8-14 mg/cm² of carbon). The device is then prepared by matching the two collectors resulting in a layered device with Al collector/positive electrode/electrolyte/negative electrode/Cu collector. The resulting active devices were 0.20-0.35 cm thick. The device was then hermetically sealed in a moisture and oxygen free container. Collectors' terminals were left with external access.

In embodiment X-ray diffraction measurements the samples of the positive and negative electrodes and electrolyte were submitted to X-ray Diffraction (XRD) in a Panalytical instrument, using CuKa radiation (A=1.54 A) with 0.20 2& steps and 0.5 s dwelling time, to determine the amount of the product present in the sample.

Electrochemical measurements: In an embodiment, galvanostatic cycling, cyclic voltammetry (CV), and electrochemical impedance spectroscopy (EIS) were performed using a SP240 potentiostat (Bio-Logic, France). Galvanostatic cycling was performed at 0.2-1.8 mA/g and between the potential limits of −10 V to 10 V versus Li/Li+ and Li⁺/Li. The CV was performed using scan rates that ranged from 1 mV/s to 500 mV/s. The EIS was performed at open circuit voltage, with a sinus amplitude of 10 mV, and frequencies that ranged from 100 mHz to 5 MHz.

Open circuit voltages (at fabrication, with battery mode charged and after discharge) were additionally measured with commercial multimeters.

Conductivity, Resistance and Permittivity calculations. In an embodiment, The ionic conductivity, resistance and permittivity of the crystalline and glassy electrolyte was measured using gold block electrodes and calculated using the equivalent circuits described in (Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014)).

### Example 2: Na-Based Compositions and Devices

In an embodiment, the synthesis of Na_{3-2*0.005}Ba_{0.005}ClO of was performed as follows: the glassy electrolyte was prepared from the commercial precursors (Panreac >99.9% for analysis), NaOH (Merck >99%) and Ba(OH)₂.8H₂O (Merck 98.5%) as described in Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014) and Example 1. After synthesis the electrolyte was heated to 100-300° C. for one hour and then cooled down, avoiding contamination with water from the air's moisture. A slurry was then prepared by grinding the electrolyte in ethanol (Merck 99.9% absolute for analysis).

In an embodiment, the preparation of the electrodes was performed as follows: the positive electrodes were prepared by adding sulfur, Ss, (Alfa Aesar Powder 99.9995% Puratronic) to the above prepared electrolyte (before mixing it with ethanol) and to carbon black (TIMCAL super C65) in a 47:46:7 weight ratio. The carbon black's XRD (Zhang, S. et al. Control of graphitization degree and defects of carbon blacks through ball-milling. RSC Adv. 4, 505 (2014)) shows the presence of graphite and amorphous carbon, probably denoting grains with an external crystalline layer and an amorphous inner phase (Zhang, S. et al. Control of graphitization degree and defects of carbon blacks through ball-milling. RSC Adv. 4, 505 (2014)). This mixture was grinded in ethanol (Merck 99.9% absolute for analysis). There were no prior perceptible reactions between the sulfur, the electrolyte and the graphite as presented in the XRD but the electrolyte could have reacted partially and form an amorphous phase that could not be distinguished from the amorphous electrolyte and carbon. The slurry was deposited on an Aluminum (Al) collector foil (Alfa Aesar Foil 99.45% 0.025 mm thick) with 2.50×2.50 cm² or 2.50×3.45 cm² and let dry at approximately 50-150° C. for 30 min, in particular corresponding to 40-80 mg/cm² of positive electrode. The electrolyte's slurry was deposited on the top of the positive electrode and let dry for approximately 50-150° C. for 30 min, in particular corresponding to 100-300 mg/cm² of electrolyte. The negative electrode was prepared by mixing carbon black from TIMCAL super C65 with ethanol (Merck 99.9% absolute for analysis) in a 12:88 weight ratio. The resulting slurry was deposited on a copper (Cu) collector foil (Alfa Aesar Foil 99.8% 0.025 mm thick) and let dry for about 10-20 min at 50-150° C., in particular corresponding to 8-14 mg/cm² of carbon. The device is then prepared by matching the two collectors resulting in a layered device with Al collector/positive electrode/electrolyte/negative electrode/Cu collector. The resulting active devices were 0.15-0.35 cm thick. The device was then hermetically sealed in a moisture and oxygen free container. Collectors' terminals were left with external access.

In an embodiment, X-ray diffraction measurements were made. Samples of the positive and negative electrodes and electrolyte were submitted to X-ray Diffraction (XRD) in a Panalytical instrument, using CuKa radiation (Λ=1.54 A) with 0.2° 2θ steps and 0.5 s dwelling time, to determine the amount of the product present in the sample.

In an embodiment, electrochemical measurements were made. Galvanostatic cycling, cyclic voltammetry (CV), and electrochemical impedance spectroscopy (EIS) were performed using a SP240 potentiostat (Bio-Logic, France). Galvanostatic cycling was performed at 0.2-1.8 mA/g and between the potential limits of −10 V to 10 V versus Na/Na⁺ and Na+/Na. The CV was performed using scan rates that ranged from 1 mV/s to 500 mV/s. The EIS was performed at open circuit voltage, with a sinus amplitude of 10 mV, and frequencies that ranged from 100 mHz to 5 MHz.

In an embodiment, open circuit voltages (at fabrication, with battery mode charged and after discharge) were additionally measured with commercial multimeters.

In an embodiment, conductivity, resistance and permittivity calculations were made. The ionic conductivity, resistance and permittivity of the crystalline and glassy electrolyte may be measured using gold block electrodes and calculated using the equivalent circuits described in (Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014)).

In an embodiment, for the devices, the equivalent circuit in FIG. 21 should be a reasonable model for three double layer capacitors (with capacitances Cc—EDLC at the interface of carbon electrode and Cs—EDLC at the interface of the sulfurbased electrode and CSCoi—EDLC inner sulfurbased electrode and aluminum collector) in parallel with their charge transfer resistance (Rc Rs and Rscoi respectively) and three additional resistances in serial (Rn=2Rₑ+Ri) corresponding to the ohmic drop at the electrodes and electrolyte.

In an embodiment, the Laplace transform was chosen for the study of the equivalent circuit in FIG. 21, characterized by its transfer function. In this case the impedance, Z(s), of a dipole is the transfer function for the current input

$$Z ( s ) = \frac{ℒ \{ Δ V ( t ) \}}{ℒ \{ Δ I ( t ) \}} = \frac{Δ V ( s )}{Δ I ( s )}$$

with ΔV=V(t)−V(0) and ΔI=I(t)−I(0). A galvanostatic charge corresponds to a Heaviside step function response which is 0 for t<0 and 1 for t>0. The Laplace transform of a Heaviside step function current is given by

$$Δ I ( s ) = ℒ \{ δ I ( t ) \} = \frac{δ l}{s} .$$

The Z_{eq}(s), for the circuit in FIG. 12, is:

$$\begin{matrix}{Z}_{eq} = {R}_{Ω} + \frac{{R}_{C}}{{sR}_{c} {C}_{c} + 1} + \frac{{R}_{S}}{{sR}_{s} {C}_{s} + 1} + \frac{{R}_{Scol}}{{sR}_{Scol} {C}_{Scol} + 1} & ( 3 ) \\ V ( s ) = {Z}_{eq} I ( s ) = \frac{δ 1}{s} ( {R}_{Ω} + \frac{{R}_{C}}{{sR}_{c} {C}_{c} + 1} + \frac{{R}_{S}}{{sR}_{s} {C}_{s} + 1} + \frac{{R}_{Scol}}{{sR}_{Scol} {C}_{Scol} + 1} ) & ( 4 ) \\ V ( t ) = {ℒ}^{- 1} \{ \frac{δ 1}{s} ( {R}_{Ω} + \frac{{R}_{C}}{{sR}_{c} {C}_{c} + 1} + \frac{{R}_{S}}{{sR}_{s} {C}_{s} + 1} + \frac{{R}_{Scol}}{{sR}_{Scol} {C}_{Scol} + 1} ) \} = δ {IR}_{Ω} + δ {IR}_{C} ( 1 - e \frac{t}{{R}_{C} {C}_{C}} ) + δ {IR}_{S} ( 1 - e \frac{t}{{R}_{S} {C}_{S}} ) + δ {IR}_{Scol} ( 1 - e \frac{t}{{R}_{Scol} {C}_{Scol}} ) & ( 5 )\end{matrix}$$

The equivalent impedance (3) is used to analyze the Cole-Cole diagram and determine the Nyquist impedance resulting from EIS.

In this case, the resulting Cole-Cole diagrams would be two perfect semi-circles. However, for real systems, sometimes this is not the case. A constant phase element (CPE), Q, is then used, instead of the capacitance C. The resulting Cole-Cole diagram corresponds to a depressed semicircle in its upper-part. The analogy between Q and C is obtained using the following equation which gives the capacitance value at the frequency corresponding to the apex of the Cole-Cole diagram.

C_{EDLC}=Q(ω_{c})^{a-1} (6)

where ω=1/(RC)^{-1/a} (at the top of the semi-circle). The pseudo-capacitance of each EDLC is then computed.

In an embodiment, considering the association of capacitors without having into account their charge transfer resistance it can calculate the equivalent capacitance. Since the capacitors are associated in serial, its equivalent capacitance is C_{eq}=C_{c}CₛC_{Scol}/(C_{c}Cₛ+C_{c}C_{Scol}+CₛC_{Scol}). If the capacitances are similar, then C_{eq}≈C/3. The capacitance of each EDLC can be written:

$${C}_{EDLC} = \frac{ɛ XA}{d} \qquad ( 7 )$$

where ∈ is the permittivity at zero-frequency (∈=∈ᵣ∈₀ where ∈ᵣ is the zero-frequency relative permittivity and ∈₀ is the vacuum permittivity, ∈₀=8.854×10⁻¹² F/m. A is the plates' surface area and d the spacing between the plates of the capacitor (the Li-ion radius or 2×Li-ion radius, depending on the EDLC).

In an embodiment, capacitance, internal resistance, energy, power and C-rate calculations were made. The capacitance determined from the CV data is given by:

$$C = \frac{1}{Δ V} \int \frac{IdV}{v} \qquad ( 8 )$$

The energy determined from the CV data is given by:

$$E = Δ V \int \frac{IdV}{v} \qquad ( 9 )$$

where C is the capacitance in Farad (F), I is the current in (A), ν is the rate in (V/s), V is the voltage in (V), ΔV is the voltage window in (V), t is time in (s) and E is the energy in (J).

The capacitance determined from the galvanostatic charge/discharge data is given by:

C=Q×3,600/ΔV_{charge/dischge} (10)

where C is the capacitance in (F), Q is the capacity in (Ah), I is the current in (A), V is the voltage in (V), and t is time in (s). Calculations of the gravimetric capacitance in (F/g) and (F/cm³) were also performed.

In an embodiment, the internal resistance of the EDLCs and electrolyte were estimated from the voltage drop (Δν=IR_{drop}) divided by the total variation in the applied current (I_{charge}−I_{discharge}) using the following equation:

$${R}_{i} = \frac{{IR}_{drop}}{{I}_{charge} - {I}_{discharge}} \qquad ( 11 )$$

For example, if I_{charge}=2.4 mA and I_{discharge}=−2.4 mA, I_{charge}−I_{discharge}=2×2.4 mA.

The energy of the device was calculated using the following equation:

E=∫VdQ (12)

where E is the energy in (J), V is the voltage in (V) and Q is the capacity in (C). The energy can be given in (Wh) if the capacity is given in (Ah). The energy density is

$$\frac{E}{Volume}$$

in which the Volume is given in cm³.

The energy of a device's capacitor was additionally calculated using the following equation:

$$E = \frac{1}{2} \frac{{C ( Δ V )}^{2}}{3 , 600} \qquad ( 13 )$$

where E is the energy in (Wh or AVh), C is the capacitance in (F) and ΔV is the discharge voltage range in (V). The energy density is

$$\frac{E}{Volume}$$

in which the Volume is given in cm³.

The power density of the device was calculated from the formula given in equation:

$$P = \frac{E}{Δ t} 3 , 600 \qquad ( 14 )$$

where P is the power density in (W/cm³), E is the volumetric energy density in (Wh/cm³) obtained from equation (12) and Δt is the discharge time, in particular in seconds.

In an embodiment, charge rate or discharge was expressed as a function of the experimental capacity and calculated from the formula given in the following equation:

$$\frac{c}{n} charge \text{/} discharge rate = C ( experimental capacity in Ah ) \text{/} n ( number of hours ) \qquad ( 15 )$$

For example, a device with a capacity of 100 mAh will be charged at a 0.024 C rate, if the current charge value is 2.4 mA which corresponds to 41.7 h (charging hours).

Throughout the description and claims the word “comprise” and variations of the word, are not intended to exclude other technical features, additives, components, or steps. Additional objectives, advantages and features of the solution will become apparent to those skilled in the art upon examination of the description or may be learned by practice of the solution.

The disclosure should not be seen in any way restricted to the embodiments described and a person with ordinary skill in the art will foresee many possibilities to modifications thereof.

The above described embodiments are combinable. The following claims further set out particular embodiments of the disclosure.

The following references are relevant to the present disclosure.
Alcantara, R., Lavela, P., Ortiz, G. F., Tirado, J. L, Carbon Microspheres Obtained from Resorcinol-Formaldehyde as High-Capacity Electrodes for Sodium-Ion Batteries. Electrochem. Solid-Stote Lett, 8, A222 (2005).
Auxer, W. The PB sodium sulfur cell for satellite battery applications. Proceedings of the International Power Sources Symposium, 32nd, Cherry Hill, N.J. (Pennington, N.J.: Electrochemical Society). A88-16601 04-44: 49-54. (1986).
Braga, M. H., Ferreira, J. A., Stockhausen, V., Oliveira, J. A., El-Azab, A. Novel Li₃ClO based glasses with superionic properties for lithium batteries. J. Mater. Chem. A, 2, 5470 (2014). Bruce, P. G., Solid State Electrochemistry, Cambridge University Press, 1994.
Braga, M. H., Ferreira, J. A., Murchison, A. J., An electrochemical solid carbon-sulfur Li-ion based device, provisional patent, (2015).
Choi, N.-S. et al. Challenges facing lithium batteries and electrical double-layer capacitors. Angew. Chem. Int. Ed. 51, 9994 (2012).
Conway, B. E., Transition from “supercapacitor” to “battery” behavior in electrochemical energy storage. J. Electrochem. Soc. 138, 1539 (1991).
Doeff, M. M., Ma, Y. P., Visco, S. J., Dejonghe, L. C, Electrochemical Insertion of Sodium into Carbon. J. Electrochem. Soc, 140, L169 (1993).
Ellis, B. L., Nazar, L. F., Sodium and sodium-ion energy storage batteries. Curr. Opin. Solid State Mater. Sci. 16, 168 (2012).
Ghidiu, M., Lukatskaya, M. R., Zhao, M.-Q., Gogotsi, Y., Barsoum, M. Conductive two-dimensional titanium carbide ‘clay’ with high volumetric capacitance. Nature, 516, (2014).
Goodenough, J. B., Park, K.-S., J. Am. Chem. Soc, 135 (4), 1167 (2013).
Heimann, B., Classic and Advanced Ceramics: From Fundamentals to Applications. John Wiley & Sons, Apr. 16, 2010.
Hong, S. Y., Kim, Y., Pa rk, Y., Choi, A., Choic, N.-S., Lee, K. T., Charge carriers in rechargeable batteries: Na ions vs. Li ions, Energy Environ. Sci. 6, 2067 (2013).
Li, H. B. et al. Amorphous nickel hydroxide nanospheres with ultrahigh capacitance and energy density as electrochemical pseudocapacitor materials. Nature Commun. 4, 1894 (2013).
Liu, R., Duay, J., Lane, T., Lee, S. B. Synthesis and characterization of Ru02/poly(3,4-ethylenedioxythiophene) composite nanotubes for supercapacitors. Phys. Chem. Chem. Phys. 12, 4309 (2010).
Jayaprakash, N., Shen, J., Moganty, S. S., Corona, A., Archer, L. A. Porous Hollow Carbon@Sulfur Composites for High-Power Lithium-Sulfur Batteries. Angew. Chem. Int. Ed. 50, 5904 (2011).
Ji, L. er al. Graphene Oxide as a Sulfur Immobilizer in High Performance Lithium/Sulfur Cells, JACS, 133, 18522 (2011).
Jung, H. Y., Karimi, M. B., Hahm, M. G., Ajayan, P. M., Jung, Y. J., Transparent, flexible supercapacitors from nano-engineered carbon films. Sci. Rep. 2, 773 (2012).
Koenig, A. A., Rasmussen, J. R. Development of a high specific power sodium sulfur cell. Proceedings of the 34th International Power Sources Symposium, p. 30. doi:10.1109/IPSS.1990.145783, 1990.
Lu, S., Chen, Y., Wu, X., Wang, Z., Yang Li, Y. Three-Dimensional Sulfur/Graphene Multifunctional Hybrid Sponges for Lithium-Sulfur Batteries with Large Areal Mass Loading. Sci. Rep. 4, 4629 (2014).
Ma, G., A lithium anode protection guided highly-stable lithium-sulfur battery. Chem. Commun. 50, 14209 (2014).
Manthiram, A., Fu, Y., Chung, S.-H., Zu, C, Su, Y.-S. Rechargeable Lithium-Sulfur Batteries, Chem. Rev. 114, 11751 (2014).
Nagao, M., Hayashi, A., Tatsumisago, M. Fabrication of favorable interface between sulfide solid electrolyte and Li metal electrode for bulk-type solid-state Li/S battery, Electrochem. Commun. 22, 177 (2012).
NRL NaSBE Experiment 1997, <http://www.nrl.navy.mil/media/news-releases/1997/nrls-sodiumn-sulfur-battery-experiment-flies-aboard-sts87> retrieved, Mar. 21, 2015.
Ong, S. P., Chevrier, V. L, Hautier, G., Jain, A., Moore, C, Kim, S., Ma, X. H., Ceder, G., Voltage, Stability and Diffusion Barrier Differences Between Sodium-ion and Lithium-ion Intercalation Materials. Energy Environ. Sci., 4, 3680 (2011).
Palomares, V., Serras, P., Villaluenga, I., Hueso, K. B., Carretero-Gonzalez, J., Rojo, T., Na— ion batteries, recent advances and present challenges to become low cost energy storage systems. Energy Environ. Sci. 5, 5884 (2012).
Song, H. K., Lee, K. T., Kim, M. G., Nazar, L. F., Cho, J., Recent progress in nanostructured cathode materials for lithium secondary batteries. Adv. Fund. Mater. 20, 3818 (2010).
Song, W., Cao, X., Wu, Z., Chen, J., Huangfu, K., Wang, X., Huang, Y., Ji, X. A study into the extracted ion number for NASICON structured Na₃V₂(PO₄)₃ in sodium-ion batteries Phys. Chem. Chem. Phys. 16, 17681 (2014).
Stahlkopf, Karl (June 2006). Taking Wind Mainstream. IEEE Spectrum, retrieved Mar. 21, 2015.
Stevens, D. A., Dahn J. R. High capacity anode materials for rechargeable sodium-ion batteries. J. Electrochem. Soc. 147, 1271 (2000).
Tarascon, J.-M., Armand, M., Issues and challenges facing rechargeable lithium batteries. Nature 414, 359 (2001).
Vlad, A. et al. Hybrid supercapacitor-battery materials for fast electrochemical charge storage. Sci. Rep. 4, 4315 (2014).
Walawalkar, R., Apt, J., Mancini, R. (2007). Economics of electric energy storage for energy arbitrage and regulation in New York. Energy Policy 35(4), 2558 (2007).
Yabuuchi, N., Kubota, K., Dahbi, M., Komaba, S., Research Development on Sodium-Ion Batteries. Chem. Rev. 114, 11636 (2014).
Xie, J. et al. Preparation of three-dimensional hybrid nanostructure-encapsulated sulfur cathode for high-rate lithium sulfur batteries. J. Power Sources, 253, 55 (2014).
Yao, H. et al. Improved lithium-sulfur batteries with a conductive coating on the separator to prevent the accumulation of inactive S-related species at the cathode-separator interface. Energy Environ. Sci. 7, 3381 (2014).
Zhang, S. S. Liquid electrolyte lithium/sulfur battery: Fundamental chemistry, problems, and solutions. Power Sources, 231, 153 (2013).
Zhang, S. et al. Control of graphitization degree and defects of carbon blacks through ball-milling. RSC Adv. 4, 505 (2014).
Zheng, S. et al. J. High Performance C/S Composite Cathodes with Conventional Carbonate-Based Electrolytes in Li—S Battery. Sci. Rep. 4, 4842 (2014).
<http://www.popsci.con/technoloviarticle2010-04/texas-town-turns-monster-battery-backup-power>> Texas Town Installs a Monster Battery for Backup Power I Popular Science. (2010 Jul. 14). retrieved on Mar. 21, 2015.

1. A layered electrochemical solid device comprising:
a positive electrode current collector comprising aluminum (Al);
a positive electrode comprising 3-80% (w/w) sulfur, less than 20% (w/w) carbon, and 3-80% (w/w/) positive electrode glass electrolyte having the formula Li₃₋₂ₓMₓHalO, wherein M is selected from the group consisting of boron (B), aluminum (Al), magnesium (Mg), calcium (Ca), strontium (Sr), and barium (Ba), Hal is selected from the group consisting of fluoride (Fl), chloride (Cl), bromide (Br), iodide (I), and mixtures thereof, X is the number of moles of M, and <x<0.01;
a glass electrolyte comprising a compound having the formula Li₃₋₂ₓMₓHalO wherein the formula is the same as that of positive electrolyte glass electrolyte;
a negative electrode comprising a carbonaceous material; and
a negative electrode current collector comprising copper (Cu).

2. The layered electrochemical device according to claim 1, wherein X is 0.002, 0.005, 0.007 or 0.01.

3. The layered electrochemical device according to claim 1, wherein Hal=0.5 Cl+0.5 I.

4. The layered electrochemical device according to claim 1, wherein the glass electrolyte has the formula Li₃₋₂ₓMₓHalO and the electrodes are charged by Li-ions from the glass electrolyte.

5. The layered electrochemical device according to claim 1, wherein the carbonaceous material of the negative electrode is selected from the group consisting of carbon black, graphite, graphene, carbon nanotubes, spongy carbon, carbon foam, carbon white, carbon composite, carbon paper, carbon fibers, carbon film, printed carbon, and mixtures thereof.

6. The layered electrochemical device according to claim 1, wherein the aluminum of the positive electrode current collector is selected from: an aluminum foam, aluminum film, aluminum foil, aluminum composite, aluminum wires, aluminum surface, or mixtures thereof.

7. The layered electrochemical device according to claim 1, wherein the copper of the negative electrode current collector is selected from: a copper foam, copper thin film, copper foil, copper composite, copper wires, copper surface, or mixtures thereof.

8. The layered electrochemical device according to claim 1, wherein the positive electrode further comprises an alcohol, an organic solvent, a polymer, or mixtures thereof.

9. The layered electrochemical device according to claim 8, wherein the alcohol is ethanol, methanol, or mixtures thereof; preferably absolute methanol, absolute ethanol, or mixtures thereof.

10. The layered electrochemical device according to claim 1, wherein said device further comprises a polymer or a resin.

11. A layered electrochemical solid device comprising:
a positive electrode current collector comprising aluminum (Al);
a positive electrode comprising 3-80% (w/w) sulfur, less than 20% (w/w) carbon, and 3-80% (w/w/) positive electrode glass electrolyte having the formula Na₃₋₂ₓMₓHalO or Na₃₋₃ₓMₓHalO, wherein M is selected from the group consisting of boron (B), aluminum (Al), magnesium (Mg), calcium (Ca), strontium (Sr), and barium (Ba), Hal is selected from the group consisting of fluoride (Fl), chloride (Cl), bromide (Br), iodide (I), and mixtures thereof, X is the number of moles of M, and 0<x<0.01;
a glass electrolyte comprising a compound having the formula Na₃₋₂ₓMₓHalO or Na₃₋₃ₓMₓHalO, wherein the formula is the same as that of positive electrolyte glass electrolyte;
a negative electrode comprising a carbonaceous material; and
a negative electrode current collector comprising copper (Cu).

12. The layered electrochemical device according to claim 11, wherein X is 0.002, 0.005, 0.007 or 0.01.

13. The layered electrochemical device according to claim 11, wherein Hal=0.5 Cl+0.5 I.

14. The layered electrochemical device according to claim 11, wherein the glass electrolyte has the formula Na₃₋₂ₓMₓHalO or Na₃₋₃ₓMₓHalO and the electrodes are charged by Na-ions from the glass electrolyte.

15. The layered electrochemical device according to claim 11, wherein the carbonaceous material of the negative electrode is selected from the group consisting of carbon black, graphite, graphene, carbon nanotubes, spongy carbon, carbon foam, carbon white, carbon composite, carbon paper, carbon fibers, carbon film, printed carbon, and mixtures thereof.

16. The layered electrochemical device according to claim 11, wherein the aluminum of the positive electrode current collector is selected from: an aluminum foam, aluminum film, aluminum foil, aluminum composite, aluminum wires, aluminum surface, or mixtures thereof.

17. The layered electrochemical device according to claim 11, wherein the copper of the negative electrode current collector is selected from: a copper foam, copper thin film, copper foil, copper composite, copper wires, copper surface, or mixtures thereof.

18. The layered electrochemical device according to claim 11, wherein the positive electrode further comprises an alcohol, an organic solvent, a polymer, or mixtures thereof.

19. The layered electrochemical device according to claim 18, wherein the alcohol is ethanol, methanol, or mixtures thereof; preferably absolute methanol, absolute ethanol, or mixtures thereof.

20. The layered electrochemical device according to claim 11, wherein said device further comprises a polymer or a resin.
